(19) United States
(12) Patent Application Publication
(10) Pub. No.: US 2026/0230619 A1
(43) Pub. Date: Aug. 6, 2026

(54) BLOCK QUANTIZATION PARAMETER ADAPTATION BASED ON SPATIAL STATISTICS AND TRANSFORM DOMAIN STATISTICS

(71) Applicant: Intel Corporation, Santa Clara, CA (US)

(72) Inventors: Minzhi Sun, Bellevue, WA (US); Ximin Zhang, San Jose, CA (US); Yi-Jen Chiu, San Jose, CA (US)

(73) Assignee: Intel Corporation, Santa Clara, CA (US)

(21) Appl. No.: 19/577,765

(22) Filed: Mar. 25, 2026

(51) Int. Cl. H04N 19/124; H04N 19/105; H04N 19/176

(52) U.S. Cl. CPC H04N 19/124; H04N 19/105; H04N 19/176

(57) ABSTRACT

Block-level quantization parameter (QP) adaptation involves assigning different QPs to different regions within a frame. A block-level QP adaptation technique computes a spatial correlation metric using the minimum sum-square difference (SSD) between the current block and candidate neighbor blocks. Blocks highly similar to their spatial neighbors are preserved at high quality by assigning a lower QP, while blocks with little correlation to their neighbors can be encoded more aggressively by assigning a higher QP. Another limitation arises where a lower QP may produce both higher distortion and a higher bit rate simultaneously. To detect this phenomenon, the number of transform coefficients whose magnitude exceeds the current quantizer step size is counted. When the count exceeds a threshold, the block is classified as a qualified block. For qualified blocks, an adaptive QP search is conducted within a bounded range to refine the block's QP.

### BACKGROUND

Video compression is a technique for making video files smaller and easier to transmit over the Internet. There are different methods and algorithms for video compression, with different performance and trade-offs. Video compression involves encoding and decoding. Encoding is the process of transforming (uncompressed) video data into a compressed format. Decoding is the process of restoring video data from the compressed format. An encoder-decoder system is called a codec.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an encoding system and a plurality of decoding systems, according to some examples of the disclosure.

FIG. 2 illustrates an example encoder to encode video frames with adaptive block quantization parameter determination and output an encoded bitstream, according to some examples of the disclosure.

FIG. 3 illustrates an example decoder to decode an encoded bitstream and output a decoded video, according to some examples of the disclosure.

FIG. 4 illustrates an implementation of block quantization parameter derivation, according to some examples of the disclosure.

FIG. 5 illustrates a search area used in computing a spatial correlation metric, according to some examples of the disclosure.

FIG. 6 illustrates a process for determining a delta quantization parameter for a delta quantization parameter (QP) block, according to some examples of the disclosure.

FIG. 7 illustrates a process for determining a delta QP for a delta QP block, according to some examples of the disclosure.

FIG. 8 illustrates an implementation of block QP refinement, according to some examples of the disclosure.

FIG. 9 illustrates a process for refining a QP, according to some examples of the disclosure.

FIG. 10 illustrates a process for merging delta quantization parameters determined using different methodologies, according to some examples of the disclosure.

FIG. 11 illustrates a method for encoding a video frame, according to some examples of the disclosure.

FIG. 12 depicts a block diagram of an example computing device, according to some examples of the disclosure.

### DETAILED DESCRIPTION

### Overview

Video coding or video compression is the process of compressing video data for storage, transmission, and playback. Video compression may involve taking a large amount of raw video data and applying one or more compression techniques to reduce the amount of data needed to represent the video while maintaining an acceptable level of visual quality. In some cases, video compression can offer efficient storage and transmission of video content over limited bandwidth networks.

A video includes one or more (temporal) sequences of video frames or frames. Frames having larger frame indices or which are associated with later timestamps relative to a current frame may be considered frames in the forward direction relative to the current frame. Frames having smaller frame indices or which are associated with previous timestamps relative to a current frame may be considered frames in the backward direction relative to the current frame. A frame may include an image, or a single still image. A frame may have millions of pixels. For example, a frame for an uncompressed 4K video may have a resolution of 3840×2160 pixels. Pixels may have luma/luminance and chroma/chrominance values. The terms “frame” and “picture” may be used interchangeably.

There are several frame types of picture types. I-frames or intra-frames may be the least compressible and do not depend on other frames to decode. I-frames may include scene change frames. An I-frame may be a reference frame for one or more other frames. P-frames may depend on data from previous frames to decode and may be more compressible than I-frames. A P-frame may be a reference frame for one or more other frames. B-frames may depend on data from previous and forward frames to decode and may be more compressible than I-frames and P-frames. A B-frame can refer to two or more frames, such as one frame in the future and one frame in the past. Other frame types may include reference B-frames and non-reference B-frames. Reference B-frames can act as a reference for another frame. A non-reference B-frame is not used as a reference for any frame. Reference B-frames are stored in a decoded picture buffer, whereas a non-reference B-frame does not need to be stored in the decoded picture buffer. P-frames and B-frames may be referred to as inter-frames. The order or encoding hierarchy in which I-frames, P-frames, and B-frames are arranged may be referred to as a group of pictures (GOP). In some cases, a frame may be an instantaneous decoder refresh (IDR) frame within a GOP. An IDR frame can indicate that no frame after the IDR frame can reference any frame before the IDR frame. Therefore, an IDR frame may signal to a decoder that the decoder may clear the decoded picture buffer. Every IDR frame may be an I-frame, but an I-frame may or may not be an IDR frame. A closed GOP may begin with an IDR frame. A slice may be a spatially distinct region of a frame that is encoded separately from any other region in the same frame.

In some cases, a frame may be partitioned into one or more blocks. Blocks may be used for block-based compression. The blocks of pixels resulting from partitioning may be referred to as partitions. Blocks may have sizes that are much smaller, such as 512×512 pixels, 256×256 pixels, 128×128 pixels, 64×64 pixels, 32×32 pixels, 16×16 pixels, 8×8 pixels, 4×4 pixels, etc. A block may include a square or rectangular region of a frame. Various video compression techniques may use different terminology for the blocks or different partitioning structures for creating the blocks. In some video compression techniques, a frame may be partitioned into Coding Tree Units (CTUs), superblocks, or macroblocks (these blocks can be referred to simply as a superblock herein). A CTU can be 32×32 pixels, 64×64 pixels, 128×128 pixels, or larger in size. A superblock can be 64×64 pixels or 128×128 pixels in size. A macroblock can be between 8×8 pixels and 16×16 pixels in size. A superblock (referring to a CTU, a superblock, or a macroblock) may be divided (separately for luma and chroma components) into coding units (CUs) or smaller blocks, e.g., according to a tree structure. A CU, or a smaller block can have a size of 64×64 pixels, 32×32 pixels, 16×16 pixels, 8×8 pixels, or 4×4 pixels.

In video compression, the QP determines the compression level and bitrate of videos. Frame-level QP adaptation can assign different QP values to different frames for bitrate control and compression efficiency. However, regions or blocks inside one video frame may be very different in the spatial or temporal domain. For example, some blocks include finer textures and details while other blocks are quite flat and smooth. Some blocks may not have visual activities across many frames, but other blocks may have fast motions. Using the same QP for all blocks inside a frame is not optimal.

Block-level QP adjustment or adaptation is a technique that assigns different QP offsets, or different delta QPs to different blocks in video encoding. The QP offset or delta QP can be applied to a frame-level QP to fine-tune the QP of the block. With block-level QP adaptation, video encoding efficiency could be further improved to better adapt to spatial and temporal characteristics of video contents. A QP, e.g., derived from a delta QP or a QP offset, to be applied to a QP unit having one or more blocks. Herein, a QP unit (or a dQP block) denotes a unit of QP adaptation and can include one or more blocks where the QP (e.g., derived from delta QP or QP offset) can vary from one QP unit to another (but the QP (e.g., delta QP or QP offset) for one or more blocks in the QP unit are the same). A QP unit can include a number of 8×8 pixel blocks. As an illustration, a QP unit can include (but is not limited to these examples) 64 8×8 pixel blocks (or 64×64 pixels), 16 8×8 pixel blocks (or 32×32 pixels), 4 8×8 pixel blocks (or 16×16 pixels), or 1 8×8 pixel block. Some solutions allow for the QP unit size to be adaptable to the content of the video. Other solutions may be limited in adapting QP to a fixed QP unit size, where the QP unit size does not adapt to different spatial and temporal characteristics of the pixels in the QP unit.

Video encoding involves a non-trivial balancing act between picture quality and file size. One control knob in this trade-off is QP. A higher QP compresses more aggressively, reducing file size but introducing visible degradation. A lower QP preserves quality at the cost of larger files. In practice, encoders assign different QP values to different frames. Within any single frame, however, different regions can be different in character. One area might have fine textures and sharp edges, e.g., a crowded bookshelf, a patch of grass, while an adjacent area might be a smooth, featureless sky. Similarly, one region might be nearly static across many frames while another region may have fast-moving objects. Assigning the same QP to every block within a frame ignores all of this variation and leads to suboptimal encoding. Too many bits are spent on blocks that do not need them, and not enough quality is preserved on blocks that matter most. Block-level QP adaptation, involving assigning slightly different QPs to different regions within a frame, addresses this problem.

Solutions for block-level QP adaptation share a common approach, where they estimate how important each block is by examining its relationship to blocks in neighboring frames over time. Those solutions work by predicting how much information a block contributes to the prediction of future encoding frames. While effective for mixed intra/inter-sequences, these temporal approaches rely on temporal correlation between frames and would not be able to produce meaningful output in situations where a video is encoded in all-intra-mode, where a video has short intervals between intra-frames, or where a video has a significant portion of frames that are intra-coded. Encoding in all-intra-mode is common in professional video editing, post-production, and high-reliability broadcast, where every or many frames are encoded independently, there are no inter-frame references, and temporal algorithms produce no meaningful output.

To address this limitation, a block-level QP adaptation solution instead examines spatial structure and statistics of the frame, rather than relying on temporal statistics of the video frames. One insight is that blocks which are highly similar to their spatial neighbors in the current frame are valuable or important, because they are likely candidates for use as prediction references by the intra-block copy (IBC) tool or by standard intra-prediction modes such as DC, horizontal, vertical, or planar prediction. Preserving those blocks at high quality (e.g., by assigning a lower QP) means subsequent blocks in encoding order can predict from them more accurately, reducing total bits and improving quality across the frame. Conversely, blocks with little correlation to their neighbors are unlikely to serve as references, and can be encoded more aggressively (e.g., by assigning a higher QP) without meaningful quality loss.

Based on this insight, the block-level QP adaptation solution calculates a spatial correlation metric that is computed for a small unit of a frame, such as an 8×8 block. The metric is defined as the minimum sum-square difference (SSD) between the current block and all candidate neighbor blocks within a defined search region, optionally normalized by the current block's own variance. In some examples, the minimum is used rather than an average because even a single highly similar neighbor is sufficient to make a block valuable as a prediction reference. Normalization by variance can ensure that the metric operates on a consistent scale regardless of whether a block is flat and smooth (e.g., low variance) or rich in texture (e.g., high variance), enabling a single lookup table (LUT) to map the metric to a delta QP value uniformly across all content types. In some examples, a calibration factor is applied as a scaling factor for the metric to ensure that the metric operates on a consistent scale. A small constant can be added to the variance in the denominator to prevent division by zero on perfectly flat blocks. The correlation metric is passed through a lookup table that maps ranges of metric values to delta QP adjustments within a range of delta QP values, e.g., −2 to +2, with the table optionally varied based on the frame's base QP for finer control.

Because different codecs define different minimum block sizes for QP changes, referred to as the delta QP block, or dQP block, the determined delta QPs of the small units of the frame (e.g., the 8×8 per-block delta QPs) are aggregated into the codec's required granularity. In some examples, the aggregation involves averaging the delta QP values of the blocks within the dQP block. In some examples, the aggregation implements special handling for screen content blocks (e.g., where many sub-blocks have negative delta QP and near-zero variance, suggesting the whole region should be preserved at high quality). In some examples, the aggregation implements special handling for blocks on frame boundaries (e.g., which are unlikely to be referenced and therefore receive nonnegative delta QP adjustments).

For videos having both intra- and inter-frames, the spatial domain delta QP (determined based on spatial information) can be combined or merged with a temporal domain delta QP (determined based on temporal information) from another solution using a defined merging rule that favors conservative adjustments and avoids over-correction when the two signals disagree.

Solutions for block-level QP adaptation have another limitation that is overlooked by block QP adaptation solutions. Specifically, the solutions overlook the failure of rate-distortion (R-D) theory at the block-level in some scenarios. R-D theory, the mathematical foundation of lossy video compression, holds that increasing QP reduces bitrate and increases distortion, while decreasing QP does the opposite. This relationship is statistically reliable when large numbers of transform coefficients are involved, as is the case at the frame-level. However, for small coding blocks with only a handful of non-zero transform coefficients, the relationship can invert, where a lower QP may produce both higher distortion and a higher bit rate simultaneously, because the quantized coefficient values happen to cluster at multiples of the quantizer step size that poorly match the actual coefficient values. A concrete example illustrates the problem. If a block has transform coefficients of 5, 6, and 7, a quantizer step size of 6 yields quantized values of 1, 1, 1 with errors of 1, 0, and 1, and a quantizer step size of 4 yields quantized values of 1, 1, 2 with errors of 1, 2, and 1. The quantizer step size of 6, a higher QP value, actually results in lower total distortion and fewer bits than using the quantizer step size of 4, a lower QP value.

To detect which blocks are susceptible to this phenomenon, a block-level QP adaptation solution computes a heuristic by counting the number of transform coefficients whose magnitude exceeds the current quantizer step size. When this count exceeds a threshold, the block is classified as a qualified block. A qualified block indicates that the discrete nature of quantization is likely to produce anomalous R-D behavior for that block. For qualified blocks, an adaptive QP search is conducted within a bounded range. An example of a bounded range can be +3 QP steps around the initial QP value, which corresponds to a quantizer step size range of approximately 0.5× to 1.5× the nominal step. For each candidate QP, the rate-distortion cost is computed, and the candidate QP that minimizes this cost is selected as the final QP for that block's quantization. Blocks that do not meet the qualification threshold, or a non-qualified block, can be quantized at the original initial QP without any search. This targeted approach limits computational overhead while correcting for cases where standard R-D assumptions break down.

Empirical validation using all-intra-encoding on both screen content and natural video demonstrated measurable BD-Rate gains on luma and chroma planes across mid and high QP ranges. BD-Rate is the standard industry metric for encoding efficiency gain. A negative BD-Rate means the same quality is achieved at a lower bitrate, or equivalently, higher quality is delivered at the same bitrate. These gains hold for challenging content types such as screen content with large flat regions and sharp text, and natural video with complex motion and texture. The disclosed techniques are particularly well-suited for data center, server-side transcoding, and video streaming applications where encoding efficiency directly translates to infrastructure cost and delivered quality at scale.

The solution is agnostic to the codec and can be applied before any encoder to improve encoder efficiency. Techniques for block-level QP adaptation described and illustrated herein may be applied to a variety of codecs. Examples of codecs can include Advanced Video Coding (AVC), High Efficiency Video Coding (HEVC), AOMedia Video 1 (AV1), AOMedia Video 2 (AV2), and Versatile Video Coding (VVC). AVC, also known as “ITU-T H.264”, was approved in 2003 and last revised 2021 Aug. 22. HEVC, also known as “ITU-T H.265”, was approved in 2013 and last revised 2023 Sep. 13. AV1 is a video coding codec designed for video transmissions over the Internet. “AV1 Bitstream & Decoding Process Specification” version 1.1.1 with Errata was last modified in 2019. AOM Working Group Approved Draft, “AV2 Bitstream & Decoding Process Specification,” was published 5 Jan. 2026. VVC, also known as “ITU-T H.266”, was finalized in 2020. It is envisioned by the disclosure that the techniques may be applied to other codecs that allow for block-level QP adjustment and adaptation.

### Video Compression

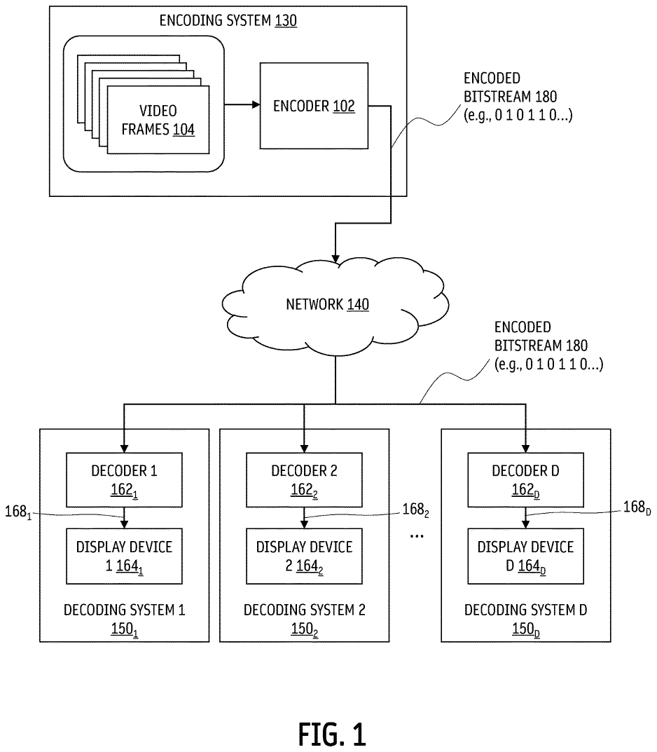

FIG. 1 illustrates encoding system 130 and one or more decoding systems 150_{1 . . . D}, according to some examples of the disclosure.

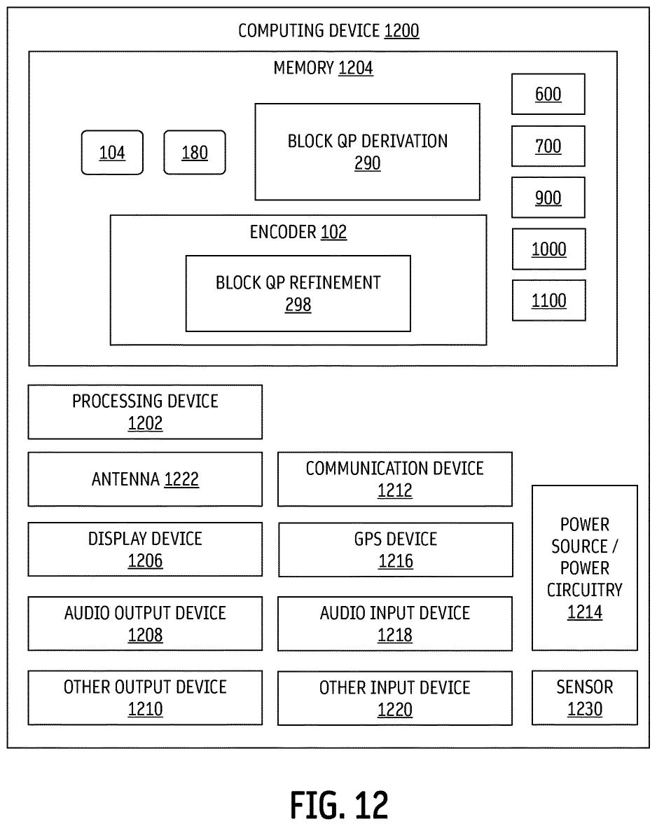

Encoding system 130 may be implemented on computing device 1200 of FIG. 12. Encoding system 130 can be implemented in the cloud or in a data center. Encoding system 130 can be implemented on a device that is used to capture the video. Encoding system 130 can be implemented on a standalone computing system. Encoding system 130 may perform the process of encoding in video compression. Encoding system 130 may receive a video (e.g., uncompressed video, original video, raw video, etc.) comprising a sequence of video frames 104. The video frames 104 may include image frames or images that make up the video. A video may have a frame rate or number of frames per second (FPS), that defines the number of frames per second of video. The higher the FPS, the more realistic and fluid the video looks. Typically, FPS is greater than 24 frames per second for a natural, realistic viewing experience to a human viewer. Examples of video may include a television episode, a movie, a short film, a short video (e.g., less than 15 seconds long), a video capturing gaming experience, computer-screen content, video conferencing content, live event broadcast content, sports content, a surveillance video, a video shot using a mobile computing device (e.g., a smartphone), etc. In some cases, video may include a mix or combination of different types of video.

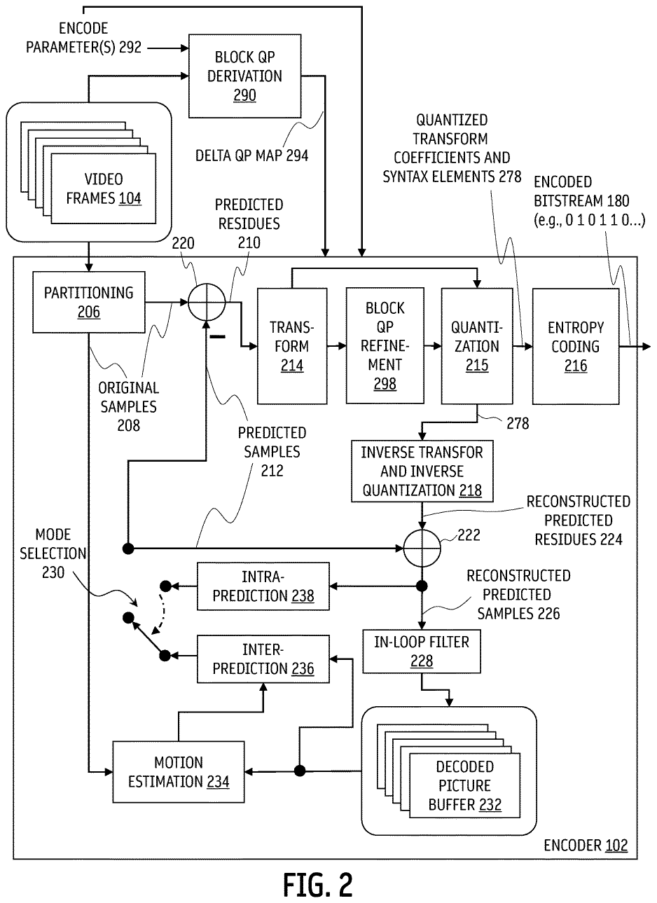

Encoding system 130 may include encoder 102 that receives video frames 104 and encodes video frames 104 into encoded bitstream 180. An example implementation of encoder 102 is illustrated in FIG. 2.

Encoded bitstream 180 may be compressed, meaning that encoded bitstream 180 may be smaller in size than video frames 104. Encoded bitstream 180 may include a series of bits, e.g., having 0's and 1's. Encoded bitstream 180 may have header information, payload information, and footer information, which may be encoded as bits in the bitstream. Header information may provide information about one or more of: the format of encoded bitstream 180, the encoding process implemented in encoder 102, the parameters of encoder 102, and metadata of encoded bitstream 180. For example, header information may include one or more of: resolution information, frame rate, aspect ratio, color space, etc. Payload information may include data representing content of video frames 104, such as sample frames, symbols, syntax elements, etc. For example, payload information may include bits that encode one or more of motion predictors, transform coefficients, prediction modes, and quantization levels of video frames 104. Footer information may indicate an end of the encoded bitstream 180. Footer information may include other information including one or more of: checksums, error correction codes, and signatures. The format of encoded bitstream 180 may vary depending on the specification of the encoding and decoding process, i.e., the codec.

Encoded bitstream 180 may include packets, where encoded video data and signaling information may be packetized. One example format is the Open Bitstream Unit (OBU), which is used in AV1 encoded bitstreams. An OBU may include a header and a payload. The header can include information about the OBU, such as information that indicates the type of OBU. Examples of OBU types may include sequence header OBU, frame header OBU, metadata OBU, temporal delimiter OBU, and tile group OBU. Payloads in OBUs may carry quantized transform coefficients and syntax elements that may be used in the decoder to properly decode the encoded video data to regenerate video frames.

Encoded bitstream 180 may be transmitted to one or more decoding systems 150_{1 . . . D}, via network 140. Network 140 may be the Internet. Network 140 may include one or more of: cellular data networks, wireless data networks, wired data networks, cable Internet networks, fiber optic networks, satellite Internet networks, etc.

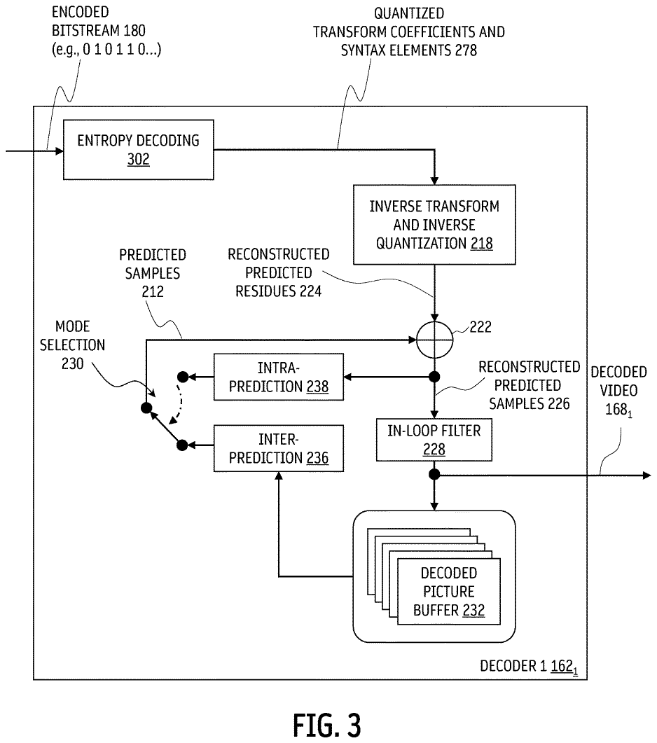

D number of decoding systems 150_{1 . . . D} are illustrated. At least one of the decoding systems 150_{1 . . . D} may be implemented on computing device 1200 of FIG. 12. Examples of systems 150_{1 . . . D} may include personal computers, mobile computing devices, gaming devices, augmented reality devices, mixed reality devices, virtual reality devices, televisions, etc. Each one of decoding systems 150_{1 . . . D} may perform the process of decoding in video compression. Each one of decoding systems 150_{1 . . . D} may include a decoder (e.g., decoder 1 . . . D 162_{1 . . . D}), and one or more display devices (e.g., display device 1 . . . D 164_{1 . . . D}). An example implementation of a decoder, e.g., decoder 1 162₁, is illustrated in FIG. 3.

For example, decoding system 1 1501 may include decoder 1 1621 and a display device 1 164₁. Decoder 1 162₁ may implement a decoding process of video compression. Decoder 1 162₁ may receive encoded bitstream 180 and produce decoded video 168₁. Decoded video 168₁ may include a series of video frames, which may be a version or reconstructed version of video frames 104 encoded by encoding system 130. Display device 1 164₁ may output the decoded video 168₁ for display to one or more human viewers or users of decoding system 1 150₁.

For example, decoding system 2 1502 may include decoder 2 1622 and a display device 2 164₂. Decoder 2 162₂ may implement a decoding process of video compression. Decoder 2 162₂ may receive encoded bitstream 180 and produce decoded video 168₂. Decoded video 168₂ may include a series of video frames, which may be a version or reconstructed version of video frames 104 encoded by encoding system 130. Display device 2 164₂ may output the decoded video 168₂ for display to one or more human viewers or users of decoding system 2 150₂.

For example, decoding system D 150_{D}, may include decoder D 162_{D} and a display device D 164_{D}. Decoder D 162_{D} may implement a decoding process of video compression. Decoder D 162_{D} may receive encoded bitstream 180 and produce decoded video 168_{D}. Decoded video 168_{D} may include a series of video frames, which may be a version or reconstructed version of video frames 104 encoded by encoding system 130. Display device D 164_{D} may output the decoded video 168_{D} for display to one or more human viewers or users of decoding system D 150_{D}.

### Video Encoder

FIG. 2 illustrates encoder 102 to encode video frames 104 with adaptive block QP determination and output an encoded bitstream, according to some examples of the disclosure. Encoder 102 may include one or more of: signal processing operations and data processing operations, including inter- and intra-prediction, transform, quantization, in-loop filtering, and entropy coding. Encoder 102 may include a reconstruction loop involving inverse quantization, and inverse transformation to guarantee that the decoder would see the same reference blocks and frames. Encoder 102 may receive video frames 104 and encode video frames 104 into encoded bitstream 180. Encoder 102 may include one or more of partitioning 206, transform 214, block QP refinement 298, quantization 215, inverse transform and inverse quantization 218, in-loop filter 228, motion estimation 234, inter-prediction 236, intra-prediction 238, and entropy coding 216.

In some examples, video frames 104 may be processed by block QP derivation 290 before encoder 102 applies an encoding process. Block QP derivation 290 and encoder 102 may form encoding system 130 as seen in FIG. 1. Block QP derivation 290 may receive video frames 104 and encode parameter(s) 292. Video frames 104 can include source video content in YUV format, which separates image brightness (luma, Y′) from color information (chrominance, U and V). Encode parameter(s) 292 can include a frame QP determined by an encoding application for a given frame. Block QP derivation 290 can determine spatial information and/or statistics, and use the spatial information and/or statistics to derive delta QP map 294. Delta QP map 294 can be used by quantization 215 to quantize transform coefficients of the video frame to be performed by one or more components in encoder 102. In some examples, block QP derivation 290 determines delta QP map 294 based on spatial statistics to improve encoding efficiency for intra-frames. Block QP derivation 290 can work alone or together with one or more other block QP adaptation solutions that rely on temporal statistics. In some examples, one or more operations of block QP derivation 290 may be implemented as software instructions being executed by a processor. In some examples, one or more operations of block QP derivation 290 may be implemented using computing circuitry designed to perform the one or more operations in hardware.

Partitioning 206 may divide a frame in video frames 104 into blocks of pixels. Different codecs may allow different variable ranges of block sizes. In one codec, a frame may be partitioned by partitioning 206 into blocks of size 128×128 or 64×64 pixels. In some cases, a frame may be partitioned by partitioning 206 into blocks of 256×256 or 512×512 pixels. In some cases, a frame may be partitioned by partitioning 206 into blocks of 32×32 or 16×16 pixels. Large blocks may be referred to as superblocks, macroblocks, or CTUs. Partitioning 206 may further divide each large block using a multi-way partition tree structure. In some cases, a partition of a superblock can be recursively divided further by partitioning 206 using the multi-way partition tree structure (e.g., down to 4×4 size blocks/partitions). In another codec, a frame may be partitioned by partitioning 206 into CTUs of size 128×128 pixels. Partitioning 206 may divide a CTU using a quadtree partitioning structure into four CUs. Partitioning 206 may further recursively divide a CU using the quadtree partitioning structure. Partitioning 206 may (further) subdivide a CU using a multi-type tree structure (e.g., a quadtree, a binary tree, or a ternary tree structure). A smallest CU may have a size of 4×4 pixels. A CU may be referred to herein as a block or a partition. Partitioning 206 may output original samples 208, e.g., as blocks of pixels, or partitions.

In VVC, a frame in video frames 104 may be partitioned into a plurality of non-overlapping CTUs. A CTU has a specified size, such as 128×128 pixels, or 64×64 pixels. The CTU can be recursively split into smaller blocks or partitions using different types of partitioning shapes. A CTU may be partitioned using a quadtree partitioning structure into 4 CUs. One or more of the CUs obtained through the quadtree partitioning structure can be recursively divided (e.g., up to three times) into smaller CUs using one of the multi-type structures, including, e.g., a quadtree, a binary tree, or a ternary tree structure to support non-square partitions. A quadtree partitioning structure can partition a CU into 4 CUs. A binary tree partitioning structure can partition a CU into 2 CUs (e.g., divided horizontally or vertically). A ternary tree structure can partition a CU into 3 CUs (e.g., divided horizontally or vertically). A smallest CU (e.g., referred to as a block or a partition) may have a size of 4×4 pixels. CUs may be larger than 4×4 pixels. It can be appreciated that a CTU may be partitioned into CUs through many different feasible partition combinations. A CTU may be partitioned in many different ways, resulting in many different partitioned results.

In some cases, one or more operations in partitioning 206 may be implemented in intra-prediction 238 and/or inter-prediction 236.

Intra-prediction 238 may predict samples of a block or partition from reconstructed predicted samples of previously encoded spatial neighboring/reference blocks of the same frame. Intra-prediction 238 may receive reconstructed predicted samples 226 (of previously encoded spatial neighbor blocks of the same frame). Reconstructed predicted samples 226 may be generated by summer 222 from reconstructed predicted residues 224 and predicted samples 212. Intra-prediction 238 may determine a suitable predictor for predicting the samples from reconstructed predicted samples of previously encoded spatial neighboring/reference blocks of the same frame (thus making an intra-prediction decision). Intra-prediction 238 may generate predicted samples 212 generated using the suitable predictor. Intra-prediction 238 may output or identify the neighboring/reference block and a predictor used in generating the predicted samples 212. The identified neighboring/reference block and predictor may be encoded in the encoded bitstream 180 to enable a decoder to reconstruct a block using the same neighboring/reference block and predictor. In one codec, intra-prediction 238 may support a number of diverse predictors, e.g., 56 different predictors. In one codec, intra-prediction 238 may support a number of diverse predictors, e.g., 95 different predictors. Some predictors, e.g., directional predictors, may capture different spatial redundancies in directional textures. Pixel values of a block can be predicted using a directional predictor in intra-prediction 238 by extrapolating pixel values of a neighboring/reference block along a certain direction. Intra-prediction 238 of different codecs may support different sets of predictors to exploit different spatial patterns within the same frame. Examples of predictors may include direct current (DC), planar, Paeth, smooth, smooth vertical, smooth horizontal, recursive-based filtering modes, chroma-from-luma, IBC, color palette or palette coding, multiple-reference line, intra-sub-partition, matrix-based intra-prediction (matrix coefficients may be defined by offline training using neural networks), angular prediction, wide-angle prediction, cross-component linear model, template matching, etc. IBC works by copying a reference block within the same frame to predict a current block. Palette coding or palette mode works by using a color palette having a few colors (e.g., 2-8 colors), and encoding a current block using indices to the color palette. In some cases, intra-prediction 238 may perform block-prediction, where a predicted block may be produced from a reconstructed neighboring/reference block of the same frame using a vector. Optionally, an interpolation filter of a certain type may be applied to the predicted block to blend pixels of the predicted block. Pixel values of a block can be predicted using a vector compensation process in intra-prediction 238 by translating a neighboring/reference block (within the same frame) according to the vector (and optionally applying an interpolation filter to the neighboring/reference block) to produce predicted samples 212. Intra-prediction 238 may output or identify the vector applied in generating predicted samples 212. In some codecs, intra-prediction 238 may encode (1) a residual vector generated from the applied vector and a vector predictor candidate, and (2) information that identifies the vector predictor candidate, rather than encoding the applied vector itself. Intra-prediction 238 may output or identify an interpolation filter type applied in generating predicted samples 212.

Motion estimation 234 and inter-prediction 236 may predict samples of a block from samples of previously encoded frames, e.g., reference frames in decoded picture buffer 232. Motion estimation 234 and inter-prediction 236 may perform operations to make inter-prediction decisions or make inter-prediction decisions. Motion estimation 234 may perform motion analysis and determine motion information for a current frame. Motion estimation 234 may determine a motion field for a current frame. A motion field may include motion vectors for blocks of a current frame. Motion estimation 234 may determine an average magnitude of motion vectors of a current frame. Motion estimation 234 may determine motion information, which may indicate how much motion is present in a current frame (e.g., large motion, very dynamic motion, small/little motion, very static).

Motion estimation 234 and inter-prediction 236 may perform motion compensation, which may involve identifying a suitable reference block and a suitable motion predictor (or motion vector predictor) for a block and optionally an interpolation filter to be applied to the reference block. Motion estimation 234 may receive original samples 208 from partitioning 206. Motion estimation 234 may receive samples from decoded picture buffer 232 (e.g., samples of previously encoded frames or reference frames). Motion estimation 234 may use a number of reference frames for determining one or more suitable motion predictors. A motion predictor may include a reference block and a motion vector that can be applied to generate a motion-compensated block or predicted block. Motion predictors may include motion vectors that capture the movement of blocks between frames in a video. Motion estimation 234 may output or identify one or more reference frames and one or more suitable motion predictors. Inter-prediction 236 may apply the one or more suitable motion predictors determined in motion estimation 234 and one or more reference frames to generate predicted samples 212. The identified reference frame(s) and motion predictor(s) may be encoded in the encoded bitstream 180 to enable a decoder to reconstruct a block using the same reference frame(s) and motion predictor(s). In one codec, motion estimation 234 may implement single reference frame prediction mode, where a single reference frame with a corresponding motion predictor is used for inter-prediction 236. Motion estimation 234 may implement compound reference frame prediction mode where two reference frames with two corresponding motion predictors are used for inter-prediction 236. In one codec, motion estimation 234 may implement techniques for searching and identifying good reference frame(s) that can yield the most efficient motion predictor. The techniques in motion estimation 234 may include searching for good reference frame(s) candidates spatially (within the same frame) and temporally (in previously encoded frames). The techniques in motion estimation 234 may include searching a deep spatial neighborhood to find a spatial candidate pool. The techniques in motion estimation 234 may include utilizing temporal motion field estimation mechanisms to generate a temporal candidate pool. The techniques in motion estimation 234 may use a motion field estimation process. After temporal and spatial candidates are ranked and a suitable motion predictor may be determined. In one codec, inter-prediction 236 may support a number of diverse motion predictors. Examples of predictors may include geometric motion vectors (complex, non-linear motion), warped motion compensation (affine transformations that capture non-translational object movements), overlapped block motion compensation, advanced compound prediction (compound wedge prediction, difference-modulated masked prediction, frame distance-based compound prediction, and compound inter-intra-prediction), dynamic spatial and temporal motion vector referencing, affine motion compensation (capturing higher-order motion such as rotation, scaling, and shearing), adaptive motion vector resolution modes, geometric partitioning modes, bidirectional optical flow, prediction refinement with optical flow, bi-prediction with weights, extended merge prediction, etc. Optionally, an interpolation filter of a certain type may be applied to the predicted block to blend pixels of the predicted block. Pixel values of a block can be predicted using the motion predictor/vector determined in a motion compensation process in motion estimation 234 and inter-prediction 236 and optionally applying an interpolation filter. In some cases, inter-prediction 236 may perform motion compensation, where a predicted block may be produced from a reconstructed reference block of a reference frame using the motion predictor/vector. Inter-prediction 236 may output or identify the motion predictor/vector applied in generating predicted samples 212. In some codecs, inter-prediction 236 may encode (1) a residual vector generated from the applied vector and a vector predictor candidate, and (2) information that identifies the vector predictor candidate, rather than encoding the applied vector itself. Inter-prediction 236 may output or identify an interpolation filter type applied in generating predicted samples 212.

Mode selection 230 may be informed by components such as motion estimation 234 to determine whether inter-prediction 236 or intra-prediction 238 may be more efficient for encoding a block (thus making an encoding decision). Inter-prediction 236 may output predicted samples 212 of a predicted block. Inter-prediction 236 may output a selected predictor and a selected interpolation filter (if applicable) that may be used to generate the predicted block. Intra-prediction 238 may output predicted samples 212 of a predicted block. Intra-prediction 238 may output a selected predictor and a selected interpolation filter (if applicable) that may be used to generate the predicted block. Regardless of the mode, predicted residues 210 may be generated by subtractor 220 by subtracting original samples 208 from predicted samples 212. In some cases, predicted residues 210 may include residual vectors from inter-prediction 236 and/or intra-prediction 238.

Transform 214 may receive predicted residues 210. Predicted residues 210 may be generated by subtractor 220 that takes original samples 208 and subtracts predicted samples 212 to output predicted residues 210. Predicted residues 210 may be referred to as the prediction error of intra-prediction 238 and inter-prediction 236 (e.g., error between the original samples and predicted samples 212). The prediction error has a smaller range of values than the original samples and can be coded with fewer bits in encoded bitstream 180. Transform 214 may implement the transformation of predicted residues 210 into transform coefficients. Transforming may include converting the predicted residues 210 from the spatial domain to the frequency domain. Transforming may include applying one or more transform kernels. Examples of transform kernels may include horizontal and vertical forms of discrete cosine transform (DCT), asymmetrical discrete sine transform (ADST), flip ADST, and identity transform (IDTX), multiple transform selection, low-frequency non-separable transform, subblock transform, non-square transforms, DCT-VIII, discrete sine transform VII (DST-VII), discrete wavelet transform (DWT), etc. Transforming may convert the predicted residues 210 into transform coefficients as the output of transform 214.

Receiving transform coefficients, quantization 215 may quantize the transform coefficients, e.g., by reducing the precision of the transform coefficients. Quantization 215 may use quantization matrices (e.g., linear and non-linear quantization matrices) having QPs. The elements in the quantization matrix can be larger for higher frequency bands and smaller for lower frequency bands, which means that the higher frequency coefficients are more coarsely quantized, and the lower frequency coefficients are more finely quantized. Quantizing may include dividing each transform coefficient by a corresponding element (e.g., a quantization parameter) in the quantization matrix and rounding to the nearest integer. Effectively, the quantization matrices may implement different QPs for different frequency bands and chroma planes and can use spatial prediction. A suitable quantization matrix can be selected and signaled for each frame and encoded in encoded bitstream 180. Quantization 215 may output quantized transform coefficients and syntax elements 278 that indicate the coding modes and parameters used in the encoding process implemented in encoder 102.

Herein, a QP refers to a parameter in video encoding that controls the level of compression by determining how much detail is preserved or discarded during the encoding process. QP can range from 0 to 51, where lower values maintain higher quality but result in larger file sizes, while higher values increase compression but introduce more visual artifacts. The QP value directly influences how the DCT coefficients are divided and rounded in quantization 215. Larger QP values cause more aggressive rounding, effectively removing high-frequency details that are less perceptible to human vision. This parameter is used in the rate-distortion optimization process of the encoder, allowing encoders to balance visual quality against bandwidth constraints. Modern encoders can dynamically adjust QP values at both frame and macroblock levels to optimize compression based on scene complexity and motion. In some cases, the adjustment to the QP is made to a base QP using a delta QP or a QP offset. Delta QP (or QP offset) is a mechanism in video encoding that allows for relative adjustments to the base QP value for specific coding units, e.g., a dQP block, or frame types. These offsets enable quantization 215 to apply different levels of compression to different parts of the video stream, optimizing the balance between quality and bitrate. For example, B-frames typically use higher QP values (positive delta) compared to I-frames since they are less critical for overall quality, while regions of high visual importance might receive negative delta QPs to preserve more detail. In many encoders, delta QPs can be configured for various structural elements like slice types, hierarchical coding layers, or specific regions of interest within frames. This granular control over quantization helps achieve better subjective quality by allocating more bits to visually significant content while maintaining efficient compression for less noticeable areas.

In some examples, block QP refinement 298 is implemented between transform 214 and quantization 215. Specifically, block QP refinement 298 can receive transform coefficients generated by transform 214 and determine transform coefficient information and/or statistics. Based on the transform coefficient information and/or statistics, block QP refinement 298 can determine whether to refine the QP to be applied in quantization 215. In some examples, the QP being refined can be based on delta QP map 294 determined by block QP derivation 290. In some examples, the QP being refined can be based on a QP determined by other means, or the QP being refined can be based on encode parameter(s) 292. A determined QP can be passed to quantization 215 to be applied to the transform coefficients from transform 214. In some examples, block QP refinement 298 refines the QP, based on transform domain statistical information, for blocks where the assumed inverse correlation between QP and rate/distortion in R-D theory does not hold. In some examples, one or more operations of block QP refinement 298 may be implemented as software instructions being executed by a processor. In some examples, one or more operations of block QP refinement 298 may be implemented using computing circuitry designed to perform the one or more operations in hardware.

In some examples, the QPs used by quantization 215 are determined by block QP derivation 290. Block QP derivation 290 may produce delta QP map 294 to be used by quantization 215. In some examples, the QPs used by quantization 215 are determined by block QP refinement 298. Determining optimal QPs is not trivial, since QPs can directly impact encoder performance.

Inverse transform and inverse quantization 218 may apply the inverse operations performed in transform 214 and quantization 215 to produce reconstructed predicted residues 224 as part of a reconstruction path to produce decoded picture buffer 232 for encoder 102. Inverse transform and inverse quantization 218 may receive quantized transform coefficients and syntax elements 278. Inverse transform and inverse quantization 218 may perform one or more inverse quantization operations, e.g., applying an inverse quantization matrix, to obtain the unquantized/original transform coefficients. Inverse transform and inverse quantization 218 may perform one or more inverse transform operations, e.g., inverse transform (e.g., inverse DCT, inverse DWT, etc.), to obtain reconstructed predicted residues 224. A reconstruction path is provided in encoder 102 to generate reference blocks and frames, which are stored in decoded picture buffer 232. The reference blocks and frames may match the blocks and frames to be generated in the decoder. The reference blocks and frames are used as reference blocks and frames by motion estimation 234, inter-prediction 236, and intra-prediction 238.

In-loop filter 228 may implement filters to smooth out artifacts introduced by the encoding process in encoder 102 (e.g., processing performed by partitioning 206, transform 214, and quantization 215). In-loop filter 228 may receive reconstructed predicted samples 226 from summer 222 and output frames to decoded picture buffer 232. Examples of in-loop filters may include a constrained low-pass filter, directional deringing filter, edge-directed conditional replacement filter, loop restoration filter, Wiener filter, self-guided restoration filters, constrained directional enhancement filter (CDEF), LMCS filter, Sample Adaptive Offset (SAO) filter, Adaptive Loop Filter (ALF), cross-component ALF, low-pass filter, deblocking filter, etc. For example, applying a deblocking filter across a boundary between two blocks can resolve blocky artifacts caused by the Gibbs phenomenon. In some examples, in-loop filter 228 may fetch data from a frame buffer having reconstructed predicted samples 226 of various blocks of a video frame. In-loop filter 228 may determine whether to apply an in-loop filter or not. In-loop filter 228 may determine one or more suitable filters that achieve good visual quality and/or one or more suitable filters that suitably remove the artifacts introduced by the encoding process in encoder 102. In-loop filter 228 may determine a type of an in-loop filter to apply across a boundary between two blocks. In-loop filter 228 may determine one or more strengths of an in-loop filter (e.g., filter coefficients) to apply across a boundary between two blocks based on the reconstructed predicted samples 226 of the two blocks. In some cases, in-loop filter 228 may take a desired bitrate into account when determining one or more suitable filters. In some cases, in-loop filter 228 may take a specified QP into account when determining one or more suitable filters. In-loop filter 228 may apply one or more (suitable) filters across a boundary that separates two blocks. After applying the one or more (suitable) filters, in-loop filter 228 may write (filtered) reconstructed samples to a frame buffer such as decoded picture buffer 232.

Entropy coding 216 may receive quantized transform coefficients and syntax elements 278 (e.g., referred to herein as symbols) and perform entropy coding. Entropy coding 216 may generate and output encoded bitstream 180. Entropy coding 216 may exploit statistical redundancy and apply lossless algorithms to encode the symbols and produce a compressed bitstream, e.g., encoded bitstream 180. Entropy coding 216 may implement some version of arithmetic coding. Different versions may have different pros and cons. In one codec, entropy coding 216 may implement (symbol-to-symbol) adaptive multi-symbol arithmetic coding. In another codec, entropy coding 216 may implement a context-based adaptive binary arithmetic coder (CABAC). Binary arithmetic coding differs from multi-symbol arithmetic coding. Binary arithmetic coding encodes only a bit at a time, e.g., having either a binary value of 0 or 1. Binary arithmetic coding may first convert each symbol into a binary representation (e.g., using a fixed number of bits per symbol). Handling just a binary value of 0 or 1 can simplify computation and reduce complexity. Binary arithmetic coding may assign a probability to each binary value (e.g., a chance of the bit having a binary value of 0 and a chance of the bit having a binary value of 1). Multi-symbol arithmetic coding performs encoding for an alphabet having at least two or three symbol values and assigns a probability to each symbol value in the alphabet. Multi-symbol arithmetic coding can encode more bits at a time, which may result in a fewer number of operations for encoding the same amount of data. Multi-symbol arithmetic coding can require more computation and storage (since probability estimates may be updated for every element in the alphabet). Maintaining and updating probabilities (e.g., cumulative probability estimates) for each possible symbol value in multi-symbol arithmetic coding can be more complex (e.g., complexity grows with alphabet size). Multi-symbol arithmetic coding is not to be confused with binary arithmetic coding, as the two different entropy coding processes are implemented differently and can result in different encoded bitstreams for the same set of quantized transform coefficients and syntax elements 278.

### Video Decoder

FIG. 3 illustrates decoder 1 162₁ to decode an encoded bitstream and output a decoded video, according to some examples of the disclosure. Decoder 1 162₁ may include one or more of: signal processing operations and data processing operations, including entropy decoding, inverse transform, inverse quantization, inter- and intra-prediction, in-loop filtering, etc. Decoder 1 162₁ may have signal and data processing operations that mirror the operations performed in the encoder. Decoder 1 162₁ may apply signal and data processing operations that are signaled in encoded bitstream 180 to reconstruct the video. Decoder 1 162₁ may receive encoded bitstream 180 and generate and output decoded video 168₁ having a plurality of video frames. The decoded video 168₁ may be provided to one or more display devices for display to one or more human viewers. Decoder 1 162₁ may include one or more of entropy decoding 302, inverse transform and inverse quantization 218, in-loop filter 228, inter-prediction 236, and intra-prediction 238. Some of the functionalities are previously described and used in the encoder, such as encoder 102 of FIG. 2.

Entropy decoding 302 may decode the encoded bitstream 180 and output symbols that were coded in the encoded bitstream 180. The symbols may include quantized transform coefficients and syntax elements 278. Entropy decoding 302 may reconstruct the symbols from the encoded bitstream 180.

Inverse transform and inverse quantization 218 may receive quantized transform coefficients and syntax elements 278 and perform operations that are performed in the encoder. Inverse transform and inverse quantization 218 may output reconstructed predicted residues 224. Summer 222 may receive reconstructed predicted residues 224 and predicted samples 212 and generate reconstructed predicted samples 226. Inverse transform and inverse quantization 218 may output syntax elements 278 having signaling information for informing/instructing/controlling operations in decoder 1 1621, such as mode selection 230, intra-prediction 238, inter-prediction 236, and in-loop filter 228.

Depending on the prediction modes signaled in the encoded bitstream 180 (e.g., as syntax elements in quantized transform coefficients and syntax elements 278), intra-prediction 238 or inter-prediction 236 may be applied to generate predicted samples 212.

Summer 222 may sum predicted samples 212 of a decoded reference block and reconstructed predicted residues 224 to produce reconstructed predicted samples 226 of a reconstructed block. For intra-prediction 238, the decoded reference block may be in the same frame as the block that is being decoded or reconstructed. For inter-prediction 236, the decoded reference block may be in a different (reference) frame in decoded picture buffer 232.

Intra-prediction 238 may determine a reconstructed vector based on a residual vector and a selected vector predictor candidate. Intra-prediction 238 may apply a reconstructed predictor or vector (e.g., in accordance with signaled predictor information) to the reconstructed block, which may be generated using a decoded reference block of the same frame. Intra-prediction 238 may apply a suitable interpolation filter type (e.g., in accordance with signaled interpolation filter information) to the reconstructed block to generate predicted samples 212.

Inter-prediction 236 may determine a reconstructed vector based on a residual vector and a selected vector predictor candidate. Inter-prediction 236 may apply a reconstructed predictor or vector (e.g., in accordance with signaled predictor information) to a reconstructed block, which may be generated using a decoded reference block of a different frame from decoded picture buffer 232. Inter-prediction 236 may apply a suitable interpolation filter type (e.g., in accordance with signaled interpolation filter information) to the reconstructed block to generate predicted samples 212.

In-loop filter 228 may receive reconstructed predicted samples 226. In-loop filter 228 may apply one or more filters signaled in the encoded bitstream 180 to the reconstructed predicted samples 226. In-loop filter 228 may output decoded video 168₁.

### Block QP Derivation Based on Spatial Information

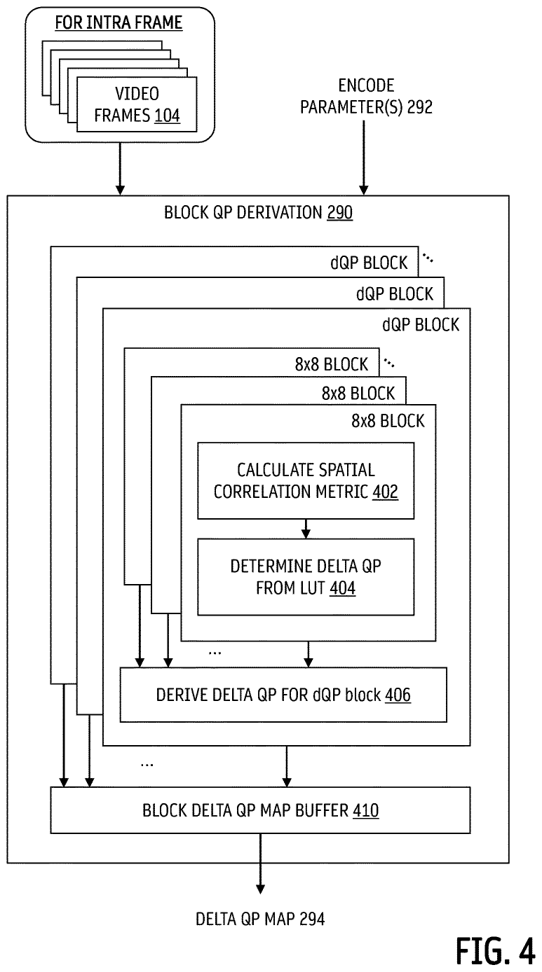

FIG. 4 illustrates an implementation of block QP derivation 290, according to some examples of the disclosure. Block QP derivation 290 receives video frames 104 and encode parameter(s) 292 as inputs and produces delta QP map 294 as output. In some examples, block QP derivation 290 operates on intra-frames. Block QP derivation 290 can implement one or more operations, including: calculating or computing a spatial correlation metric for a block, e.g., 8×8 block based on a corresponding search region, determining a delta QP that is mapped to the spatial correlation metric in a lookup table, and deriving a delta QP for a dQP block having a plurality of blocks. In some examples, block QP derivation 290 can determine, for a block of a video frame, a delta QP based on a spatial correlation metric, aggregates those delta quantization parameters across blocks of a delta QP block and stores the results in block delta QP map buffer 410 for downstream encoding use.

In some examples, block QP derivation 290 comprises a hierarchical block processing structure in which a dQP block can include one or more (8×8) blocks. For a given block, block QP derivation 290 performs two operations: calculate spatial correlation metric 402 and determine delta QP from LUT 404. The outputs of these per-block operations are collected and passed to derive delta QP for dQP block 406, which determines a delta QP for the given dQP block. Processing for multiple blocks of a dQP block can proceed in parallel and/or iteratively across the video frame. Processing for multiple dQP blocks can proceed in parallel and/or iteratively across the video frame.

Calculate spatial correlation metric 402 determines, for a given block of a video frame from video frames 104, a spatial correlation metric based on the block and one or more spatially neighboring blocks of the video frame. In some examples, the spatial correlation metric comprises a minimum difference of one or more differences between the block and the one or more spatially neighboring blocks. In some examples, a difference is computed as a SSD normalized by a variance of luma pixels of the block. In some examples, the difference is further scaled by a calibration factor, s₀.

The spatial correlation metric, e.g., corre_metric, determined in calculate spatial correlation metric 402 can be defined as the minimum difference between the current n×m block and its neighbors in a search region. The difference can be calculated as SSD normalized by the current block variance in the luma plane.

$$corre\_metric = {min}_{( x , y ) ∈ S} \frac{1 + {{\sum }_{( i , j ) ∈ n \times m} [ {p}_{( i , j )} - {q}_{( i + x , j + y )} ]}^{2}}{1 + var} * {s}_{0} \qquad eq . ( 1 )$$

$$var = {{\sum }_{( i , j ) ∈ 8 \times 8} [ {p}_{( i , j )} - average ]}^{2} \qquad eq . ( 2 )$$

p_{(i,j)} is the pixel value inside the current n×m block, i=0, 1, . . . n, and j=0, 1, . . . m. q_{(i+x,j+y)} represents the collocated pixel value in a block after moving the current block by x pixels in the horizontal direction and y pixels in the vertical direction. S is the search region which represents the collection of block movements, var is the variance of the current n×m block as defined in equation (2). s₀ is a constant scaling factor or calibration factor (e.g., set as 5, 10, 20, 30, or 40). A high value of corre_metric indicates weak correlation between a current block and its neighbors. A low value of corre_metric indicates strong correlation between the current block and its neighbors. It is envisioned that other metrics besides SSD can be used to measure spatial correlation, such as sum of absolute difference (SAD).

The calibration factor s₀ in equation (1) can serve as a scaling factor that controls the sensitivity of the spatial correlation metric to block variance. In some examples, s₀ is set to a value of 5, which produces a metric that is highly sensitive to small differences between blocks, resulting in more aggressive delta QP differentiation across the frame. In some examples, s₀ is set to a larger value such as 20 or 40, which reduces the metric's sensitivity to variance differences and produces a more conservative delta QP distribution. The selection of s₀ can be content-dependent. For screen content having large flat regions and sharp text boundaries, a smaller s₀ may be preferred to sharpen the distinction between highly correlated flat blocks and weakly correlated edge blocks. For natural video having complex textures, a larger s₀ may be preferred to avoid over-differentiating blocks whose variance differences are attributable to texture complexity rather than prediction reference utility. In some examples, s₀ is determined empirically through offline calibration on a representative set of training content and held fixed for a given encoding configuration. In some examples, s₀ is selected adaptively based on the frame QP, where a higher frame QP corresponds to a larger s₀ to reduce the aggressiveness of delta QP adjustments in high-compression scenarios.

In equation (1), a small constant is added to the variance in the denominator to prevent division by zero on perfectly flat blocks, where all pixel values within the block are identical and the variance is zero. In some examples, the constant is set to a value of 1, yielding a denominator of 1+var that evaluates to 1 for flat blocks, effectively making the spatial correlation metric equal to the raw unnormalized SSD for those blocks. This ensures that perfectly flat blocks, such as solid-color regions in screen content, are not excluded from the spatial correlation computation and continue to receive meaningful delta QP assignments from the lookup table. In some examples, the constant is set to a value between 1 and 10, where larger values reduce the influence of variance normalization for near-flat blocks and produce a metric that more closely resembles the unnormalized SSD across a wider range of block variances. The choice of constant does not affect the metric for blocks with high variance, where the variance term dominates the denominator, but has a meaningful effect on the metric for near-flat blocks where variance is small relative to the constant. In some examples, the constant is set adaptively based on the average block variance of the frame, ensuring consistent metric behavior across frames with varying spatial complexity.

While the spatial correlation metric described herein uses sum-square difference (SSD) as the measure of difference between the current block and its candidate neighbor blocks, other difference metrics may be used. In some examples, the sum of absolute differences (SAD) is used in place of SSD. SAD computes the sum of the absolute values of pixel-wise differences between two blocks, rather than the sum of squared differences. Because SAD does not square the per-pixel differences, it is less sensitive to large outlier differences and may produce a more robust metric in the presence of isolated pixel noise or compression artifacts in the reference blocks. SAD also has a lower computational cost than SSD, since it avoids the multiplication operations required for squaring, which can be advantageous in hardware encoder implementations where area and power consumption are constrained. SSD, by contrast, penalizes large pixel differences more heavily than small ones, making it more discriminating for blocks with strong structural similarity, where even a single large pixel difference is indicative of weak spatial correlation. In some examples, the choice between SSD and SAD is made based on the target platform. SSD is preferred for software encoder implementations where floating-point operations are inexpensive, while SAD is preferred for hardware encoder implementations where integer arithmetic and low gate count are prioritized. It is envisioned that other difference metrics, such as sum of absolute transformed differences (SATD), may also be used to measure spatial correlation between blocks.

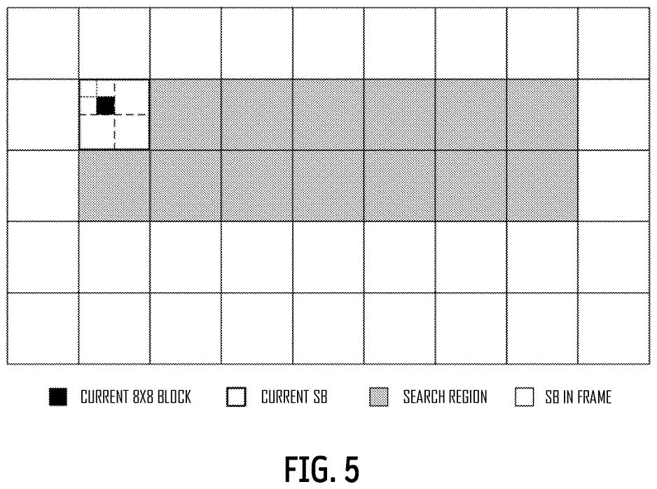

FIG. 5 illustrates a search area or region S used in computing the spatial correlation metric, according to some examples of the disclosure. The search region S can be defined as a collection of super blocks (SB) inside the current (intra) frame following the super block where the current n×m block is located in encoding order, which ensures the current block could possibly be used to generate prediction for the following blocks encoding. In some examples, the search region S is defined as max 6 SBs on the right on the same row up to the right boundary of the current frame and max 7 SBs below the current SB row up to the right boundary. FIG. 5 illustrates a search region S when the block size is 8×8 and SB size is 32×32.

Referring back to FIG. 4, the spatial correlation metric, e.g., corre_metric, determined in calculate spatial correlation metric 402 is used to identify blocks that have strong spatial correlations with their local neighbors. Such blocks would have a high probability of being used as reference blocks of IBC mode in the encoder.

For flat and smooth blocks which have very low variance, intra-prediction modes like DC, horizontal, vertical or planar mode are very likely to be selected by the encoder for such blocks. In these scenarios, with the same importance as reference for neighboring blocks, usually the SSD value of a flat block is smaller than a block with rich textures. For blocks with many textures, as long as the texture structure is the same between the current block and its neighboring blocks, those blocks are still a good reference for IBC even though there might be some differences in non-structural details. Using variance, e.g., var as calculated in equation (2), to normalize the SSD value when calculating the spatial correlation metric can put different contents of blocks on the same scale.

Determine delta QP from LUT 404 determines a delta QP from a lookup table based on the spatial correlation metric produced by calculate spatial correlation metric 402. In some examples, a max delta QP range supported is [−2, 2], and four thresholds are defined:

| corre_metric | delta QP |
|---|---|
| [0, 25] | −2 |
| [26, 50] | −1 |
| [51, 250] | 0 |
| [251, 500] | 1 |
| >500 | 2 |

For blocks which are highly correlated with their neighbors and have low correlation metric values, the LUT entries used in determine delta QP from LUT 404 can be set to ensure that the delta QP for the block can be negative or zero, which helps to give a good quality of prediction when these blocks are used as reference for IBC or certain intra-prediction modes. On the other hand, blocks that have weak correlation with their neighbors and hence high correlation metric values, the LUT entries used in determine delta QP from LUT 404 can be set to ensure that the delta QP for the block can be positive, which helps to save bits when encoding these blocks since they are less likely referenced by following blocks in encoding order.

In some examples, different LUTs can be used for different frame QPs. In some examples, the lookup table is selected from a plurality of lookup tables based on a frame QP associated with the video frame. Selecting an LUT based on a frame QP can ensure that the mapping from spatial correlation metric to delta QP varies with the encoding configuration supplied by encode parameter(s) 292, which may include the frame QP. In some examples, a higher frame QP can correspond to an LUT having a larger max delta QP range with more thresholds, and a lower frame QP can correspond to an LUT having a smaller max delta QP range with fewer thresholds.

In some examples, different LUTs can be used for different block variances (e.g., different values for var as defined by equation (2)). The spatial correlation metric calculation as illustrated by equation (1) can avoid normalization by block variance, if different LUTs are used for different block variances. In some examples, the lookup table is selected from a plurality of lookup tables based on the block variance (e.g., in the luma plane) associated with the video frame. Selecting an LUT based on a block variance can ensure that the mapping from spatial correlation metric to delta QP varies with spatial statistics of the block.

Derive delta QP for dQP block 406 determines a delta QP for a dQP block using one or more delta QPs determined for the one or more blocks within that dQP block. In some examples, derive delta QP for dQP block 406 averages the delta quantization parameters of the constituent blocks to produce the delta QP for the dQP block (finds a mean of the delta QPs). In some examples, derive delta QP for dQP block 406 finds a median of the delta QPs of the constituent blocks to produce the delta QP for the dQP block. In some examples, derive delta QP for dQP block 406 finds a mode of the delta QPs of the constituent blocks to produce the delta QP for the dQP block. In some examples, derive delta QP for dQP block 406 finds a maximum of the delta QPs of the constituent blocks to produce the delta QP for the dQP block. In some examples, derive delta QP for dQP block 406 finds a minimum of the delta QPs of the constituent blocks to produce the delta QP for the dQP block. In some examples, derive delta QP for dQP block 406 assigns a smallest delta QP based on classifying the block and the one or more further blocks as having screen content. In some examples, derive delta QP for dQP block 406 assigns a predefined nonnegative delta QP based on determining that the dQP block is on a boundary of the video frame.

Block delta QP map buffer 410 stores one or more delta QPs determined by derive delta QP for dQP block 406 for one or more dQP blocks of the video frame. Block delta QP map buffer 410 outputs delta QP map 294, which provides the per-block delta QPs to a downstream encoder (e.g., encoder 102) for use in determining the QP to be applied when encoding each block of the video frame.

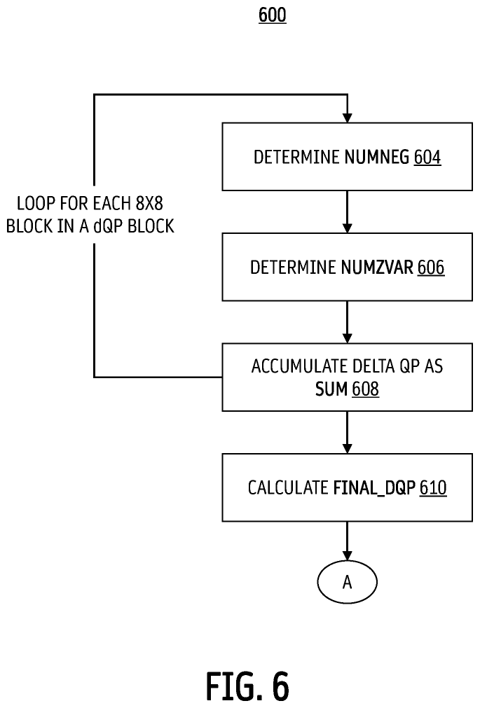

FIG. 6 illustrates process 600 for determining a delta quantization parameter for a delta QP block, according to some examples of the disclosure. Process 600 can be implemented as part of derive delta QP for dQP block 406 of FIG. 4. dQP block refers to a minimal block size which allows different QP in a video encoder. The block size for a dQP block can vary with different codec standards. For example, AVC only allows QP change per macroblock (MB). However, from HEVC onwards, encoders allow for QP to change at a sub-CTU, or quantization group (QG) level and the granularity at which QP modification occurs can be signaled by the encoder in bitstream syntax (e.g., picture header). For intra-frame encoding, dQP block size can be adaptive to the spatial complexity of a region. The more complex and the more details in a region, the smaller dQP block size may be. For simplicity and the sake of discussion and illustration, delta QPs are determined for 8×8 blocks based on spatial correlation metrics of the 8×8 blocks, the dQP block size is 32×32, and SB size is 64×64. It is envisioned that process 600 can be applied to other block sizes for a block and other block sizes for a dQP block. In some examples, the dQP block size is fixed for a frame. In some examples, the dQP block size is fixed for a video. In some examples, the dQP block size can vary within a video.

To derive the delta QP value for a dQP block, process 600 aggregates the delta QP values of the 8×8 blocks inside one dQP block. The aggregation process, involving operation 604, operation 606, and operation 608, may be repeated for the various 8×8 blocks in a dQP block. Process 600 can determine a delta QP for a dQP block by iterating over individual 8×8 blocks within the dQP block and accumulating intermediate values before computing a final delta QP (final_dqp). Process 600 continues at connector A upon completion.

In operation 604, one or more 8×8 blocks which have a negative value of delta QP are counted and stored as NumNeg. Operation 604 may count the number of 8×8 blocks within the dQP block whose individually determined delta QP is negative. In some examples, NumNeg reflects the degree to which the spatial correlation metric, computed across the constituent 8×8 blocks, indicates that the dQP block as a whole is likely to serve as a prediction reference for spatially neighboring blocks in encoding order.

In operation 606, one or more 8×8 blocks which have zero-variance are counted and stored as NumZvar. Operation 606 may count the number of 8×8 blocks which have zero-variance. In some examples, operation 606 may include counting the number of 8×8 blocks within the dQP block whose luma pixel variance is zero or near-zero. In some examples, NumZvar serves as an indicator of screen content, where large flat or uniform regions produce zero-variance 8×8 blocks and warrant special handling when deriving the delta QP for the enclosing dQP block.

In operation 608, the delta QP of individual 8×8 blocks are accumulated as Sum. Accumulation in operation 608 can include adding the delta QPs determined for each 8×8 block processed in the loop across the dQP block. Performing this accumulation across the loop iterations produces a running total Sum that reflects the aggregate spatial correlation characteristics of all 8×8 blocks within the dQP block.

In operation 610, a final dQP value, final_dqp, can be calculated, which can be used as the delta QP for the dQP block. Calculating the final dQP value can include calculating an average of the delta QPs over the 8×8 blocks in the dQP block. In some examples, calculating the average comprises dividing the accumulated Sum from operation 608 by the number of 8×8 blocks in the dQP block.

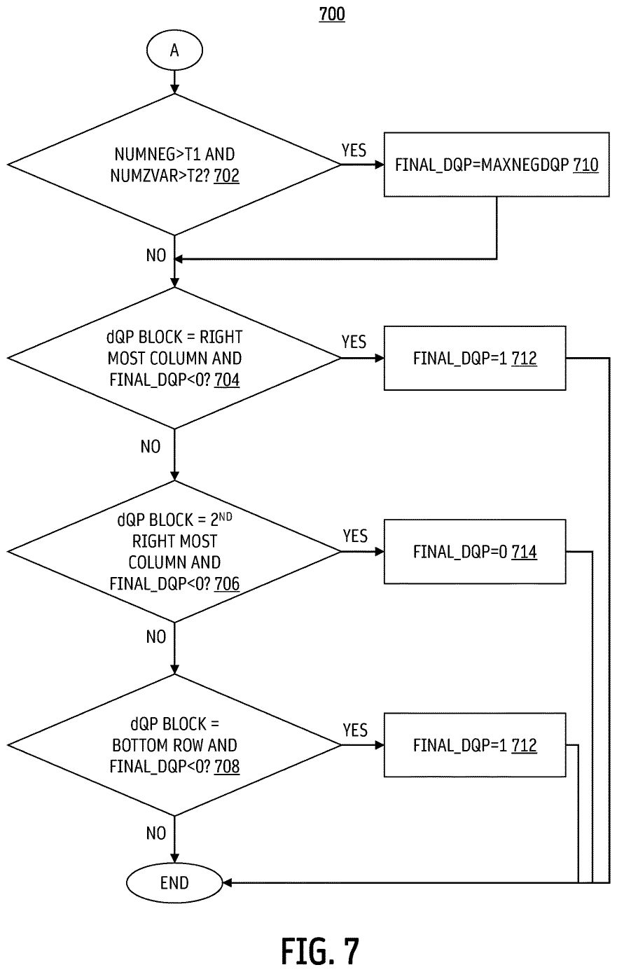

FIG. 7 illustrates process 700 for determining a delta QP for a delta QP block, according to some examples of the disclosure. Process 700 can be implemented as part of derive delta QP for dQP block 406 of FIG. 4. For simplicity and the sake of discussion and illustration, the dQP block size is 32×32, and SB size is 64×64. It is envisioned that process 700 can be applied to other block sizes for a block and other block sizes for a dQP block. In some examples, the dQP block size is fixed for a frame. In some examples, the dQP block size is fixed for a video. In some examples, the dQP block size can vary within a video.

Process 700 can continue from connector A (previously seen in FIG. 6) and optionally performs special handling to finalize the final dQP value for a dQP block based on screen content classification and frame boundary conditions. Process 700 applies one or more conditional checks that can override the averaged delta QP computed in process 600 of FIG. 6, ensuring that the QP assigned to boundary blocks and screen content blocks reflects their distinct encoding characteristics.

In operation 702, process 700 evaluates whether NumNeg exceeds threshold T1 and whether NumZvar exceeds threshold T2. If NumNeg exceeds threshold T1 and NumZvar exceeds T2, the condition in operation 702 is met, and the YES path is followed and process 700 proceeds to operation 710. Otherwise, NumNeg does not exceed threshold T1 and/or NumZvar does not exceed T2, the NO path is followed to proceed to operation 704.

Performing this evaluation in operation 702 determines whether the dQP block qualifies as screen content, based on the proportion of constituent 8×8 blocks that carry a negative delta QP and the proportion with near-zero luma pixel variance. In some examples, a dQP block whose 8×8 blocks are predominantly negative in delta QP and predominantly flat in variance is characteristic of screen content (e.g., such as text, graphics, or solid-color regions) where preserving high quality across the entire dQP block benefits the accuracy of intra-prediction for spatially neighboring blocks in encoding order.

In operation 710, process 700 assigns or sets the final delta QP value, final_dqp to maxnegdQP, which represents the smallest delta QP supported by the encoding configuration or the most negative delta QP of the delta QP range, e.g., −2, −3, or −4. Assigning the smallest delta QP to a screen content dQP block ensures that the QP applied when encoding those blocks is minimized, preserving quality in regions that are highly likely to serve as spatially neighboring block references.

In operation 704, process 700 evaluates whether the dQP block occupies the rightmost column of the video frame and whether the final dQP value for the dQP block (final_dqp) is less than zero. If the dQP block occupies the rightmost column of the video frame and the final dQP value for the dQP block (final_dqp) is less than zero, the condition in operation 704 is met, and the YES path is followed and process 700 proceeds to operation 712. Otherwise, the dQP block does not occupy the rightmost column of the video frame and/or the final dQP value for the dQP block (final_dqp) is greater than or equal to zero, the NO path is followed to proceed to operation 706.

Performing this evaluation in operation 704 determines whether a dQP block is the rightmost column. Such blocks lie at the spatial boundary of the frame and have no further spatially neighboring blocks to their right in encoding order. Allowing a negative delta dQP for such blocks would lower the QP without a corresponding benefit to prediction quality for any downstream block.

In operation 712, process 700 assigns the final dQP value to be equal to 1, which is a predefined nonnegative delta QP. Assigning a nonnegative delta QP to rightmost column blocks ensures that encoding resources are not expended on quality preservation for blocks that are unlikely to be referenced by spatially neighboring blocks in encoding order, thereby improving overall encoding efficiency.

In operation 706, process 700 evaluates whether the dQP block occupies the second rightmost column of the video frame and whether the final dQP value for the dQP block (final_dqp) is less than zero. If the dQP block occupies the second rightmost column of the video frame and the final dQP value for the dQP block (final_dqp) is less than zero, the condition in operation 706 is met, and the YES path is followed and process 700 proceeds to operation 714. Otherwise, the dQP block does not occupy the second rightmost column of the video frame and/or the final dQP value for the dQP block (final_dqp) is greater than or equal to zero, the NO path is followed to proceed to operation 708.

Performing this evaluation in operation 706 determines whether a dQP block is the second rightmost column. Such second rightmost column blocks have limited utility as spatially neighboring block references because their proximity to the frame boundary reduces the number of downstream blocks for which they can serve as prediction sources.

In operation 714, process 700 assigns the final dQP value to be equal to 0. Assigning a delta QP of zero to second rightmost column blocks applies a more moderate boundary correction than the rightmost column, reflecting that these blocks retain partial reference utility and warrant a neutral rather than positive adjustment to the QP.

In operation 708, process 700 evaluates whether the dQP block occupies the bottom row of the video frame and whether the final dQP value for the dQP block (final_dqp) is less than zero. If the dQP block occupies the bottom row of the video frame and the final dQP value for the dQP block (final_dqp) is less than zero, the condition in operation 708 is met, and the YES path is followed and process 700 proceeds to operation 712. Otherwise, the dQP block does not occupy the bottom row of the video frame and/or the final dQP value for the dQP block (final_dqp) is greater than or equal to zero, the NO path is followed to proceed to the END marker.

Performing this evaluation in operation 708 determines whether a dQP block is in the bottom row. Such bottom row blocks, similar to rightmost column blocks, lie at the spatial boundary of the frame in encoding order and have no spatially neighboring blocks below them to benefit from quality preservation. Where the condition at operation 708 is satisfied, process 700 proceeds to operation 712, assigning the final dQP value to be equal to 1 for the same reasons as the rightmost column case.

Where none of the boundary conditions at operation 704, operation 706, or operation 708 are satisfied, process 700 can proceed to the END marker with final delta QP (e.g., as determined by process 600 of FIG. 6) unchanged for the dQP block. In some examples, other boundary conditions may be evaluated, e.g., determining whether the block is in a second-to-last bottom row. While 0 and 1 are used as examples of nonnegative delta QP values in operation 712 and operation 714, it is envisioned that other nonnegative delta QP values can be used.

In some examples, process 700 includes assigning a smallest delta QP (e.g., in operation 710) based on classifying the dQP block as having screen content (e.g., in operation 702), using NumNeg and NumZvar to make that classification determination.

In some examples, process 700 includes assigning a predefined nonnegative delta QP (e.g., in operation 712 or operation 714) on determining that the dQP block is on a boundary of the video frame (e.g., in operation 704, operation 706, and operation 708), reflecting that boundary blocks are less likely to be referenced by spatially neighboring blocks in encoding order and therefore do not benefit from quality-preserving reductions to the QP.

### Block QP Refinement Based on Transform Coefficient Statistics

In video coding, the quantization process can be applied as shown in equation (3), where x represents the transform coefficient, Δ represents the quantization step size, w represents the dead-zone parameter which is in the range of 0~Δ, c represents the quantized value, x̅ represents the dequantized coefficient. └·┘ represents a rounding down operation.

$$C = ⌊ \frac{x}{Δ} + w ⌋ , \overline{x} = Δ \times c \qquad eq . ( 3 )$$

With the above process, a smaller quantization step size usually brings higher quality (and bit rate), and a larger step size usually brings lower quality and a lower bit rate. This assumption is statistically correct when the number of coefficients is big enough and the coefficients follow certain distributions such as Gaussian or Laplacian. However, this may not be true with a limited number of coefficients. This can be explained with a simple example. Suppose a block with 3 non-zero coefficients: 5, 6, and 7:
If the quantizer step size is 7, the quantized values are 1, 1, 1, the quantization errors are 2, 1, 0.
If the quantizer step size is 6, the quantized values are 1, 1, 1, the quantization errors are 1, 0, 1.
If the quantizer step size is 5, the quantized values are 1, 1, 1, the quantization errors are 0, 1, 2.
If the quantizer step size is 4, the quantized values are 1, 1, 2, the quantization errors are 1, 2, 1.

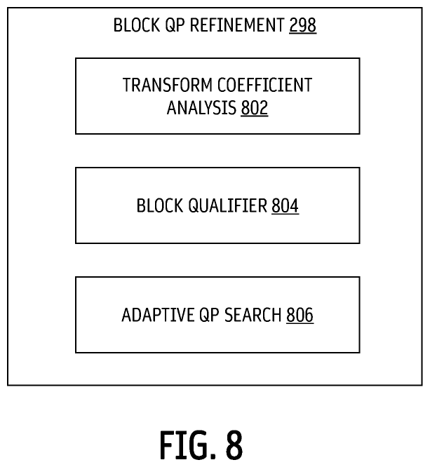

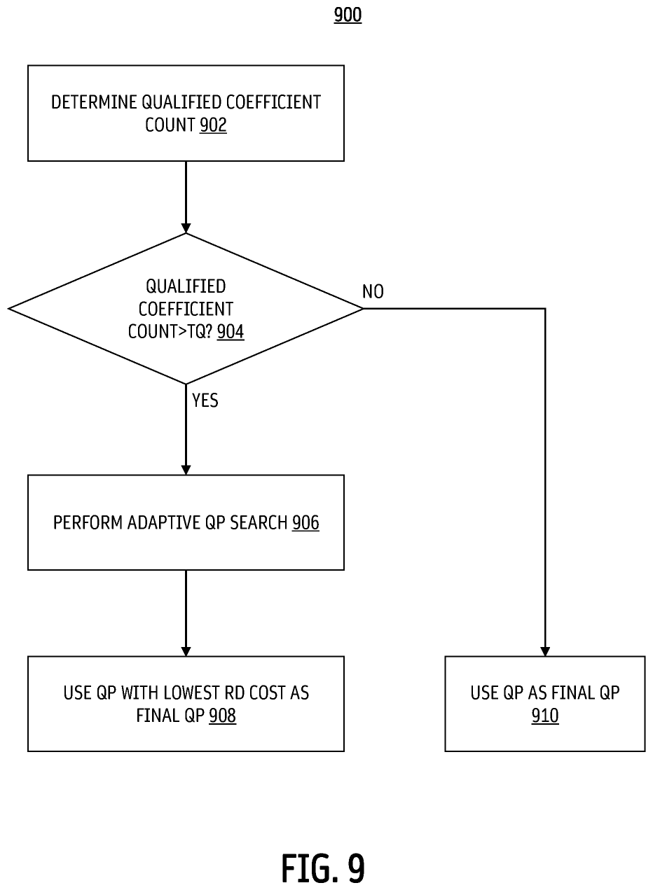

From this example, it can be seen that the smaller quantizer step 4 brings higher distortion and higher bits. An optimal quantizer step for this example is 6, which can achieve higher quality and lower bits at the same time. Motivated by the above observation, an adaptive block delta QP refinement method can be implemented. The method is illustrated in FIGS. 8-9.

FIG. 8 illustrates an implementation of block QP refinement 298, according to some examples of the disclosure. Block QP refinement 298 can operate within the encoder pipeline (e.g., in encoder 102) after the transform stage (e.g., transform 214 of FIG. 2) and adjusts the QP for a block or the dQP block of a video frame based on transform coefficient statistics. Block QP refinement 298 comprises one or more of transform coefficient analysis 802, block qualifier 804, and adaptive QP search 806.

For each encoding block, the transform coefficients and initial QP (e.g., a frame QP+block delta QP if it exists) are fed into coefficient analysis 802. In some examples, the block delta QP can be determined utilizing block QP derivation 290. In some examples, the block delta QP can be determined utilizing one or more of process 600, process 700, and process 1000. Transform coefficient analysis 802 can receive one or more transform coefficients for a block of the video frame. Transform coefficient analysis 802 can derive a quantization step QS corresponding to the QP for that block. Transform coefficient analysis 802 can calculate or determine the quantizer step QS based on the initial QP. The total number is used as or referred to as the qualified coefficient count. In some examples, transform coefficient analysis 802 can count or tally the number of transform coefficients whose magnitude exceeds the quantization step QS and produces a qualified coefficient count. In some examples, a transform coefficient that exceeds the quantization step QS will produce a non-zero quantized value, such that the qualified coefficient count reflects the number of coefficients that will contribute to the encoded bitstream and influence rate-distortion cost. Transform coefficient analysis 802 may supply the qualified coefficient count and the quantization step to block qualifier 804.

Block qualifier 804 evaluates whether the one or more transform coefficients and the quantization step meet a refinement condition. Block qualifier 804 evaluates whether the qualified count meets a refinement condition. Performing this evaluation can include comparing the qualified coefficient count produced by transform coefficient analysis 802 against a threshold. In some examples, the refinement condition is met when the qualified coefficient count exceeds the threshold, indicating that the block contains a sufficient number of transform coefficients near integer multiples of the quantization step such that the assumed inverse correlation between the QP and rate-distortion cost may not hold. Block qualifier 804 determines whether a block is a qualified block and passes that determination to adaptive QP search 806.

Adaptive QP search 806 adjusts or refines the initial QP based on the output of block qualifier 804. For a qualified block, adaptive QP search 806 finds the QP which achieves the smallest RD-cost. Adaptive QP search 806 evaluates one or more rate-distortion costs using one or more candidate QPs, determines a selected QP based on the one or more rate-distortion costs, and sets the selected QP as the QP for encoding the block. In some examples, the candidate QPs span a search range corresponding to a quantization step range of approximately 0.5 to 1.5 times the nominal quantization step (e.g., 0.5QS~1.5QS), for example, QP−3 to QP+3 in AVC, HEVC, or VVC. The optimal QP with the lowest RD-cost can be used as the final QP for the actual quantization of the coefficients in the current block (in quantization 215 of FIG. 2). For a block that does not meet the refinement condition (thus the block is not a qualified block), adaptive QP search 806 retains the initial QP without modification.

In some examples, block QP refinement 298 applies to both intra- and inter-coded blocks. In some examples, the quantization parameter input to block QP refinement 298 can include one or more of a frame QP for the frame and a delta QP determined by block QP derivation 290.

FIG. 9 illustrates process 900 for refining a QP, according to some examples of the disclosure. Process 900 can adjust the QP for a block of a video frame based on transform coefficient statistics. Process 900 implements the refinement condition evaluation and adaptive quantization parameter selection performed by block QP refinement 298 of FIG. 2. Process 900 can be applied to intra- and/or inter-coded blocks.

In operation 902, process 900 determines a qualified coefficient count for the block. Determining the qualified coefficient count can include counting the number of transform coefficients of the block whose magnitude exceeds the quantization step corresponding to the current QP. In some examples, a transform coefficient whose magnitude exceeds the quantization step will produce a non-zero quantized value, such that the qualified coefficient count reflects the number of coefficients that materially contribute to the encoded bitstream and to rate-distortion cost. The quantization step is derived from the quantization parameter, which can include a frame QP and a delta quantization parameter determined by block QP derivation 290 of FIG. 2.

In operation 904, process 900 evaluates whether the qualified coefficient count exceeds threshold TQ. If the qualified coefficient count is larger than a threshold TQ, the corresponding block is classified as a qualified block. If the current block is not a qualified block, the original initial QP is used as the final QP for the actual quantization of the coefficients in the current block. Performing this evaluation determines whether the one or more transform coefficients and the quantization step meet the refinement condition. In some examples, a block whose qualified coefficient count exceeds TQ contains a distribution of transform coefficients sufficiently concentrated near integer multiples of the quantization step that the assumed inverse correlation between the QP and rate-distortion cost may not hold, making that block a candidate for QP adjustment. Where the qualified coefficient count exceeds TQ (e.g., indicating a qualified block), process 900 follows the YES path and proceeds to operation 906. Where the qualified coefficient count does not exceed TQ (e.g., indicating a non-qualified block), process 900 follows the NO path and proceeds to operation 910.

The threshold TQ used in operation 904 of process 900 can control the proportion of blocks that are classified as qualified blocks and subjected to the adaptive QP search. In some examples, TQ is set to a value of 3, meaning that a block must have at least 3 transform coefficients whose magnitude exceeds the quantization step size before it is classified as a qualified block. A value of TQ equal to 3 reflects the empirical observation that R-D theory inversion is most likely to occur when multiple coefficients are simultaneously clustered near integer multiples of the quantization step size, and that a single such coefficient is insufficient to reliably predict anomalous R-D behavior. In some examples, TQ is set to a value of 2 for smaller block sizes, such as 4×4 blocks, where the total number of transform coefficients is limited and a lower threshold is needed to detect susceptible blocks. In some examples, TQ is set to a value of 5 for larger block sizes, such as 16×16 or 32×32 blocks, where a higher count of qualifying coefficients is required before the overhead of an adaptive QP search is warranted. In some examples, TQ is determined empirically through offline calibration and may vary with codec, content type, and target bitrate. Blocks that do not meet the qualification threshold are quantized at the initial QP without modification, limiting computational overhead to only those blocks where the adaptive search is likely to yield a rate-distortion benefit.

In operation 906, process 900 performs an adaptive QP search for the block. Performing adaptive QP search can include evaluating one or more rate-distortion costs using one or more candidate quantization parameters spanning a search range around the current quantization parameter. In some examples, the search range corresponds to a quantization step range of approximately 0.5 to 1.5 times the nominal quantization step, for example, candidate quantization parameters from QP−3 to QP+3 in AVC, HEVC, or VVC encoders. Performing adaptive QP search produces a set of rate-distortion costs, individually associated with a respective candidate quantization parameter, from which a selected quantization parameter is determined.

For each candidate QP evaluated during the adaptive QP search in operation 906 of process 900, a rate-distortion cost can be computed using a Lagrangian formulation. In some examples, the rate-distortion cost is defined as: RDcost=D+λ·R. D is the distortion between the original and reconstructed block, R is the estimated bitrate required to encode the block at the candidate QP, and λ is a Lagrange multiplier that controls the trade-off between distortion and rate. In some examples, D is computed as the sum-square difference (SSD) between the original transform coefficients and the dequantized coefficients produced by quantizing at the candidate QP. In some examples, R is estimated as the number of bits required to entropy-code the quantized transform coefficients at the candidate QP, using the same entropy coding context as would be applied during actual encoding. In some examples, λ is derived from a QP and optionally a content adaptive scaling constant. The candidate QP that produces the lowest RD-cost across the search range is selected as the final QP for the block. Because the search range is bounded in operation 906, the computational overhead of evaluating multiple candidate QPs is limited and predictable.

In operation 908, process 900 sets the QP with the lowest rate-distortion cost as the final QP for the block. Using or setting the selected QP as the QP can include replacing the initial QP with the candidate QP that minimizes the evaluated rate-distortion cost. In some examples, the selected QP may be higher than the initial QP, reflecting that a larger quantization step can simultaneously reduce distortion and bit rate for blocks where the refinement condition is met. When a larger quantization step can achieve a better RD-cost, it means that the standard rate-distortion theory did not apply to the qualified block, operating on small numbers of transform coefficients.

In operation 910, process 900 uses the current/initial QP as the final QP for the block, without modification. Retaining the initial quantization parameter for blocks that do not meet the refinement condition at operation 904 limits the computational overhead of block QP refinement 298 to only those blocks where adjustment is likely to yield a rate-distortion benefit, while leaving all other blocks unaffected.

Integration with Other Block QP Adaptation Techniques

In video editing, professional video post-production, or applications where there is a high requirement for error resilience, it is a common practice that all frames are intra-frame coded. In this case, other block QP adaptation solutions cannot work as expected because every frame is independent, and there is no reference relationship between frames and no temporal correlation to be used for block QP calculation. The approach can be particularly beneficial in these cases because the approach utilizes spatial statistics of blocks to adjust QP for different blocks and improve encoding efficiency.

When a video sequence encoded includes both intra- and inter-frames, the approach can work together with other adaptive block QP solutions. In other words, the approach implemented in block QP derivation 290 and illustrated in process 600 and/or process 700 can be used alongside other block QP adaptation techniques. For intra-frames, two or more delta QP values can be determined for a block using different approaches. In some examples, two delta QP values can be determined: dqp1 using the approach described and illustrated herein and dqp2 from another approach where delta QPs are assigned for blocks based on the estimation of how much information of, or how likely the block is referenced by, neighbor frames (e.g., temporal correlation). The final delta QP for this block can be decided as follows:

$$if dqp 1 = dqp 2 , final\_dqp is set to dqp 1 or dqp 2.$$

$$if dqp 1 * dqp 2 >= 0 , final\_dqp = min ( dqp 1 , dqp 2 ) .$$

$$if dqp 1 * dqp 2 < 0 , final\_dqp = dqp 1 + dqp 2.$$

For inter-frames, as temporal correlation is more important than spatial correlation in efficient video encoding, block delta QP can be fully decided by dqp2 (final_dqp=dqp2).

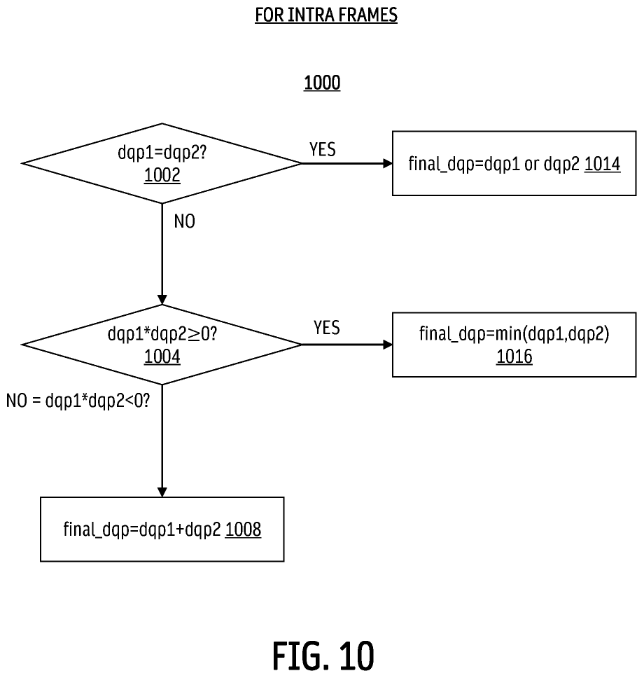

FIG. 10 illustrates process 1000 for merging delta QPs determined using different methodologies, according to some examples of the disclosure. Process 1000 can determine a final delta QP for a block of a frame (e.g., an intra-frame) by merging a delta QP determined based on spatial correlation (e.g., through process 600 and/or process 700) with a further delta QP determined based on temporal correlation. Process 1000 applies one or more conditional cases that together define a conservative combination rule ensuring the merged delta QP does not over-correct relative to either input signal.

In operation 1002, process 1000 evaluates whether dqp1 equals dqp2, where dqp1 is the delta QP that can be based on spatial correlation and dqp2 is the further delta QP determined based on temporal correlation. Where the condition at operation 1002 is satisfied, process 1000 follows the YES path and proceeds to operation 1014. Where the condition at operation 1002 is not satisfied, process 1000 follows the NO path and proceeds to operation 1004.

In operation 1014, process 1000 assigns dqp1 or dqp2 as the final delta QP. In some examples, assigning either value is equivalent when dqp1 equals dqp2, and the selection between them does not affect the QP determined for encoding the block.

In operation 1004, process 1000 evaluates whether the product of dqp1 and dqp2 is greater than or equal to zero. A product greater than or equal to zero indicates that dqp1 and dqp2 are of the same sign (e.g., both nonnegative or both non-positive), meaning the spatial correlation-based and temporal correlation-based signals agree on the direction of the delta QP adjustment. Where the condition at operation 1004 is satisfied, process 1000 follows the YES path and proceeds to operation 1016. Where the condition at operation 1004 is not satisfied (which means that the product of dqp1 and dqp2 is less than zero), process 1000 follows the NO path and proceeds to operation 1008.

In operation 1016, process 1000 assigns the minimum of dqp1 and dqp2 as the final delta QP. Assigning the minimum when the two delta QPs share the same sign applies a conservative merging strategy. When both signals agree the block warrants a lower QP, the less aggressive of the two reductions is selected. When both agree the block warrants a higher QP, the smaller positive adjustment is applied. In some examples, this prevents the combined system from over-reducing the QP for a block that one signal considers only moderately important, while still reflecting the consensus direction of both the spatial and temporal correlation assessments.

In operation 1008, process 1000 assigns the sum of dqp1 and dqp2 as the final delta QP, corresponding to the case where the product of dqp1 and dqp2 is less than zero. A negative product indicates that dqp1 and dqp2 are of opposite signs. When dqp1 and dqp2 are of opposite signs, the spatial correlation-based and temporal correlation-based signals disagree on the direction of adjustment. In some examples, summing the two opposing delta QPs produces a final delta QP of reduced magnitude, or zero where the two values are equal and opposite, reflecting that neither signal alone is sufficient to override the other and that a neutral or moderated adjustment to the QP is appropriate for the block. The final delta QP is thus a middle ground or a compromise between dqp1 and dqp2.

### Methods for Encoding Video Frames

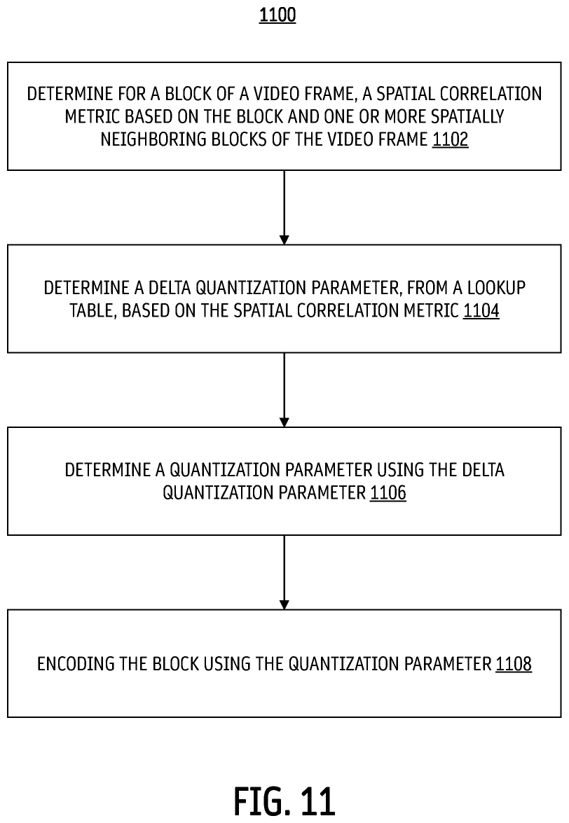

FIG. 11 illustrates method 1100 for encoding a video frame, according to some examples of the disclosure. Method 1100 can be performed by block QP derivation 290 and/or delta QP map 294 of FIG. 2.

In 1102, a spatial correlation metric is determined for a block of a video frame based on the block and one or more spatially neighboring blocks of the video frame.

In 1104, a delta QP is determined from a lookup table based on the spatial correlation metric.

In 1106, a quantization parameter is determined using the delta quantization parameter.

In 1108, the block is encoded using the quantization parameter.

### Example Computing Device

FIG. 12 is a block diagram of an apparatus or a system, e.g., an example computing device 1200, according to some examples of the disclosure. One or more computing devices 1200 may be used to implement the functionalities described with the FIGS. and herein. A number of components are illustrated in FIG. 12 that can be included in computing device 1200, but any one or more of these components may be omitted or duplicated, as suitable for the application. In some examples, some or all of the components included in computing device 1200 may be attached to one or more motherboards. In some examples, some or all of these components are fabricated onto a single system on a chip (SoC) die. Additionally, in various examples, computing device 1200 may not include one or more of the components illustrated in FIG. 12, and computing device 1200 may include interface circuitry for coupling to the one or more components. For example, computing device 1200 may not include a display device 1206, and may include display device interface circuitry (e.g., a connector and driver circuitry) to which a display device 1206 may be coupled. In another set of examples, computing device 1200 may not include audio input device 1218 or audio output device 1208 and may include audio input or output device interface circuitry (e.g., connectors and supporting circuitry) to which an audio input device 1218 or audio output device 1208 may be coupled.

Computing device 1200 may include processing device 1202 (e.g., one or more processing devices, one or more of the same type of processing device, one or more of different types of processing devices). Processing device 1202 may include processing circuitry or electronic circuitry that processes electronic data from data storage elements (e.g., registers, memory, resistors, capacitors, quantum bit cells) to transform that electronic data into other electronic data that may be stored in registers and/or memory. Examples of processing device 1202 may include a CPU, a GPU, a quantum processor, a machine learning processor, an artificial intelligence processor, a neural-network processor, an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 1200 may include memory 1204, which may itself include one or more memory devices such as volatile memory (e.g., DRAM), nonvolatile memory (e.g., read-only memory (ROM)), high-bandwidth memory (HBM), flash memory, solid-state memory, and/or a hard drive. Memory 1204 includes one or more non-transitory computer-readable storage media. In some examples, memory 1204 may include memory that shares a die with the processing device 1202.

In some examples, memory 1204 includes one or more non-transitory computer-readable media storing instructions executable to perform operations described herein, such as operations illustrated in FIGS. 2, 4, and 8, process 600, process 700, process 900, process 1000, and method 1100. In some examples, memory 1204 includes one or more non-transitory computer-readable media storing instructions executable to perform one or more operations of encoder 102. In some examples, memory 1204 includes one or more non-transitory computer-readable media storing instructions executable to perform one or more operations of block QP derivation 290. In some examples, memory 1204 includes one or more non-transitory computer-readable media storing instructions executable to perform one or more operations of block QP refinement 298. The instructions stored in memory 1204 may be executed by processing device 1202.

In some examples, memory 1204 may store data, e.g., data structures, binary data, bits, metadata, files, blobs, etc., as described with the FIGS. and herein. Memory 1204 may include one or more non-transitory computer-readable media storing one or more of: input frames to the encoder (e.g., video frames 104), intermediate data structures computed by the encoder, bitstream generated by the encoder (encoded bitstream 180), bitstream received by a decoder (encoded bitstream 180), intermediate data structures computed by the decoder, and reconstructed frames generated by the decoder. Memory 1204 may include one or more non-transitory computer-readable media storing one or more of: data received and/or data generated by process 600 of FIG. 6. Memory 1204 may include one or more non-transitory computer-readable media storing one or more of: data received and/or data generated by process 700 of FIG. 7. Memory 1204 may include one or more non-transitory computer-readable media storing one or more of: data received and/or data generated by process 900 of FIG. 9. Memory 1204 may include one or more non-transitory computer-readable media storing one or more of: data received and/or data generated by process 1000 of FIG. 10. Memory 1204 may include one or more non-transitory computer-readable media storing one or more of: data received and/or data generated by method 1100 of FIG. 11. Memory 1204 may include decoded picture buffer 232.

In some examples, computing device 1200 may include a communication device 1212 (e.g., one or more communication devices). For example, communication device 1212 may be configured for managing wired and/or wireless communications for the transfer of data to and from computing device 1200. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. Communication device 1212 may implement any of a number of wireless standards or protocols. Communication device 1212 may operate in accordance with other wireless protocols in other examples. Computing device 1200 may include an antenna 1222 to facilitate wireless communications and/or to receive other wireless communications (such as radio frequency transmissions). Computing device 1200 may include receiver circuits and/or transmitter circuits. In some examples, communication device 1212 may manage wired communications, such as electrical, optical, or any other suitable communication protocols (e.g., the Ethernet). As noted above, communication device 1212 may include multiple communication chips. For instance, a first communication device 1212 may be dedicated to shorter-range wireless communications such as Wi-Fi or Bluetooth, and a second communication device 1212 may be dedicated to longer-range wireless communications. In some examples, a first communication device 1212 may be dedicated to wireless communications, and a second communication device 1212 may be dedicated to wired communications.

Computing device 1200 may include power source/power circuitry 1214. Power source/power circuitry 1214 may include one or more energy storage devices (e.g., batteries or capacitors) and/or circuitry for coupling components of computing device 1200 to an energy source separate from computing device 1200 (e.g., DC power, AC power, etc.).

Computing device 1200 may include display device 1206 (or corresponding interface circuitry, as discussed above). Display device 1206 may include any visual indicators, such as a heads-up display, a computer monitor, a projector, a touchscreen display, a liquid crystal display (LCD), a light-emitting diode display, or a flat panel display, for example.

Computing device 1200 may include audio output device 1208 (or corresponding interface circuitry, as discussed above). Audio output device 1208 may include any device that generates an audible indicator, such as speakers, headsets, or earbuds, for example.

Computing device 1200 may include audio input device 1218 (or corresponding interface circuitry, as discussed above). Audio input device 1218 may include any device that generates a signal representative of a sound, such as microphones, microphone arrays, or digital instruments (e.g., instruments having a musical instrument digital interface (MIDI) output).

Computing device 1200 may include global positioning system (GPS) device 1216 (or corresponding interface circuitry, as discussed above). GPS device 1216 may be in communication with a satellite-based system and may receive a location of computing device 1200, as known in the art.

Computing device 1200 may include sensor 1230 (or one or more sensors). Computing device 1200 may include corresponding interface circuitry, as discussed above. Sensor 1230 may sense physical phenomena and translate the physical phenomena into electrical signals that can be processed by, e.g., processing device 1202. Examples of sensor 1230 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1200 may include another output device 1210 (or corresponding interface circuitry, as discussed above). Examples of the other output device 1210 may include an audio codec, a video codec, a printer, a wired or wireless transmitter for providing information to other devices, haptic output device, gas output device, vibrational output device, lighting output device, home automation controller, or an additional storage device.

Computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1200 may have any desired form factor, such as a handheld or mobile computer system (e.g., a cell phone, a smartphone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some examples, computing device 1200 may be any other electronic device that processes data.

### Select Examples

Example 1 provides one or more non-transitory computer-readable media storing instructions that, when executed by one or more processors, cause the one or more processors to perform operations including: determining, for a block of a video frame, a spatial correlation metric based on the block and one or more spatially neighboring blocks of the video frame; determining a delta quantization parameter, from a lookup table, based on the spatial correlation metric; determining a quantization parameter using the delta quantization parameter; and encoding the block using the quantization parameter.

Example 2 provides the one or more non-transitory computer-readable media of example 1, where determining the spatial correlation metric includes determining a minimum difference of one or more differences between the block and the one or more spatially neighboring blocks.

Example 3 provides the one or more non-transitory computer-readable media of example 2, where a difference between the block and a spatially neighboring block includes a sum-square difference.

Example 4 provides the one or more non-transitory computer-readable media of example 2 or 3, where a difference between the block and a spatially neighboring block is normalized by a variance of luma pixels of the block.

Example 5 provides the one or more non-transitory computer-readable media of any one of examples 2-4, where a difference between the block and a spatially neighboring block is scaled by a calibration factor.

Example 6 provides the one or more non-transitory computer-readable media of any one of examples 1-5, where the one or more spatially neighboring blocks of the video frame includes one or more superblocks following the block in encoding order.

Example 7 provides the one or more non-transitory computer-readable media of any one of examples 1-6, where the lookup table is selected from a plurality of lookup tables based on a frame quantization parameter associated with the video frame.

Example 8 provides the one or more non-transitory computer-readable media of any one of examples 1-7, where determining the quantization parameter includes determining the quantization parameter using the delta quantization parameter and one or more further delta quantization parameters determined for one or more further blocks of the video frame.

Example 9 provides the one or more non-transitory computer-readable media of any one of examples 1-8, where determining the quantization parameter includes averaging the delta quantization parameter and one or more further delta quantization parameters determined for one or more further blocks of the video frame.

Example 10 provides the one or more non-transitory computer-readable media of any one of examples 1-9, where determining the quantization parameter includes assigning a smallest delta quantization parameter based on classifying the block and one or more further blocks of the video frame as having screen content.

Example 11 provides the one or more non-transitory computer-readable media of any one of examples 1-10, where determining the quantization parameter includes assigning a predefined nonnegative delta quantization parameter based on determining that the block is on a boundary of the video frame.

Example 12 provides the one or more non-transitory computer-readable media of any one of examples 1-11, where the operations further include: based on the delta quantization parameter being equal to a further delta quantization parameter determined based on temporal correlation, assigning the delta quantization parameter or the further delta quantization parameter as the delta quantization parameter; based on a product of the delta quantization parameter and the further delta quantization parameter being greater than or equal to zero, assigning a minimum of the delta quantization parameter and the further delta quantization parameter as the delta quantization parameter; and based on the product of the delta quantization parameter and the further delta quantization parameter being less than zero, assigning a sum of the delta quantization parameter and the further delta quantization parameter as the delta quantization parameter.

Example 13 provides the one or more non-transitory computer-readable media of any one of examples 1-12, where the operations further include: determining one or more transform coefficients for the block of the video frame; and adjusting the quantization parameter based on the one or more transform coefficients and a quantization step corresponding to the quantization parameter.

Example 14 provides the one or more non-transitory computer-readable media of example 13, where adjusting the quantization parameter includes based on the one or more transform coefficients and the quantization step meeting a refinement condition, evaluating one or more rate-distortion costs using one or more candidate quantization parameters, determining a selected quantization parameter based on the one or more rate-distortion costs; and setting the selected quantization parameter as the quantization parameter.

Example 15 provides an apparatus, including one or more processors; and one or more non-transitory computer-readable media storing instructions that, when executed by the one or more processors, cause the one or more processors to perform operations including determining, for a block of a video frame, a spatial correlation metric based on the block and one or more spatially neighboring blocks of the video frame; determining a delta quantization parameter, from a lookup table, based on the spatial correlation metric; determining a quantization parameter using the delta quantization parameter; and encoding the block using the quantization parameter.

Example 16 provides the apparatus of example 15, where determining the spatial correlation metric includes determining a minimum difference of one or more differences between the block and the one or more spatially neighboring blocks.

Example 17 provides the apparatus of example 16, where a difference between the block and a spatially neighboring block includes a sum-square difference.

Example 18 provides the apparatus of example 16 or 17, where a difference between the block and a spatially neighboring block is normalized by a variance of luma pixels of the block.

Example 19 provides the apparatus of any one of examples 16-18, where a difference between the block and a spatially neighboring block is scaled by a calibration factor.

Example 20 provides the apparatus of any one of examples 15-19, where the one or more spatially neighboring blocks of the video frame includes one or more superblocks following the block in encoding order.

Example 21 provides the apparatus of any one of examples 15-20, where the lookup table is selected from a plurality of lookup tables based on a frame quantization parameter associated with the video frame.

Example 22 provides the apparatus of any one of examples 15-21, where determining the quantization parameter includes determining the quantization parameter using the delta quantization parameter and one or more further delta quantization parameters determined for one or more further blocks of the video frame.

Example 23 provides the apparatus of any one of examples 15-22, where determining the quantization parameter includes averaging the delta quantization parameter and one or more further delta quantization parameters determined for one or more further blocks of the video frame.

Example 24 provides the apparatus of any one of examples 15-23, where determining the quantization parameter includes assigning a smallest delta quantization parameter based on classifying the block and one or more further blocks of the video frame as having screen content.

Example 25 provides the apparatus of any one of examples 15-24, where determining the quantization parameter includes assigning a predefined nonnegative delta quantization parameter based on determining that the block is on a boundary of the video frame.

Example 26 provides the apparatus of any one of examples 15-25, where the operations further include: based on the delta quantization parameter being equal to a further delta quantization parameter determined based on temporal correlation, assigning the delta quantization parameter or the further delta quantization parameter as the delta quantization parameter; based on a product of the delta quantization parameter and the further delta quantization parameter being greater than or equal to zero, assigning a minimum of the delta quantization parameter and the further delta quantization parameter as the delta quantization parameter; and based on the product of the delta quantization parameter and the further delta quantization parameter being less than zero, assigning a sum of the delta quantization parameter and the further delta quantization parameter as the delta quantization parameter.

Example 27 provides the apparatus of any one of examples 15-26, where the operations further include: determining one or more transform coefficients for the block of the video frame; and adjusting the quantization parameter based on the one or more transform coefficients and a quantization step corresponding to the quantization parameter.

Example 28 provides the apparatus of example 27, where adjusting the quantization parameter includes based on the one or more transform coefficients and the quantization step meeting a refinement condition, evaluating one or more rate-distortion costs using one or more candidate quantization parameters, determining a selected quantization parameter based on the one or more rate-distortion costs; and setting the selected quantization parameter as the quantization parameter.

Example 29 provides a computer-implemented method, including determining, for a block of a video frame, a spatial correlation metric based on the block and one or more spatially neighboring blocks of the video frame; determining a delta quantization parameter, from a lookup table, based on the spatial correlation metric; determining a quantization parameter using the delta quantization parameter; and encoding the block using the quantization parameter.

Example 30 provides the computer-implemented method of example 29, where determining the spatial correlation metric includes determining a minimum difference of one or more differences between the block and the one or more spatially neighboring blocks.

Example 31 provides the computer-implemented method of example 30, where a difference between the block and a spatially neighboring block includes a sum-square difference.

Example 32 provides the computer-implemented method of example 30 or 31, where a difference between the block and a spatially neighboring block is normalized by a variance of luma pixels of the block.

Example 33 provides the computer-implemented method of any one of examples 30-32, where a difference between the block and a spatially neighboring block is scaled by a calibration factor.

Example 34 provides the computer-implemented method of any one of examples 29-33, where the one or more spatially neighboring blocks of the video frame includes one or more superblocks following the block in encoding order.

Example 35 provides the computer-implemented method of any one of examples 29-34, where the lookup table is selected from a plurality of lookup tables based on a frame quantization parameter associated with the video frame.

Example 36 provides the computer-implemented method of any one of examples 29-35, where determining the quantization parameter includes determining the quantization parameter using the delta quantization parameter and one or more further delta quantization parameters determined for one or more further blocks of the video frame.

Example 37 provides the computer-implemented method of any one of examples 29-36, where determining the quantization parameter includes averaging the delta quantization parameter and one or more further delta quantization parameters determined for one or more further blocks of the video frame.

Example 38 provides the computer-implemented method of any one of examples 29-37, where determining the quantization parameter includes assigning a smallest delta quantization parameter based on classifying the block and one or more further blocks of the video frame as having screen content.

Example 39 provides the computer-implemented method of any one of examples 29-38, where determining the quantization parameter includes assigning a predefined nonnegative delta quantization parameter based on determining that the block is on a boundary of the video frame.

Example 40 provides the computer-implemented method of any one of examples 29-39, further including based on the delta quantization parameter being equal to a further delta quantization parameter determined based on temporal correlation, assigning the delta quantization parameter or the further delta quantization parameter as the delta quantization parameter; based on a product of the delta quantization parameter and the further delta quantization parameter being greater than or equal to zero, assigning a minimum of the delta quantization parameter and the further delta quantization parameter as the delta quantization parameter; and based on the product of the delta quantization parameter and the further delta quantization parameter being less than zero, assigning a sum of the delta quantization parameter and the further delta quantization parameter as the delta quantization parameter.

Example 41 provides the computer-implemented method of any one of examples 29-40, further including determining one or more transform coefficients for the block of the video frame; and adjusting the quantization parameter based on the one or more transform coefficients and a quantization step corresponding to the quantization parameter.

Example 42 provides the computer-implemented method of example 41, where adjusting the quantization parameter includes based on the one or more transform coefficients and the quantization step meeting a refinement condition, evaluating one or more rate-distortion costs using one or more candidate quantization parameters, determining a selected quantization parameter based on the one or more rate-distortion costs; and setting the selected quantization parameter as the quantization parameter.

Example 43 provides an apparatus comprising means for performing a method according to any one of claims 29-42.

Example 44 provides a computer program product comprising instructions which, when executed by a processor, cause the processor to perform a method according to any one of claims 29-42.

Example 45 provides machine-readable storage including machine-readable instructions, which, when executed, cause a computer to implement a method according to any one of claims 29-42.

Example 46 provides a computer program comprising instructions which, when the computer program is executed by a processing device, cause the processing device to carry out a method according to any one of claims 29-42.

Example 47 provides a computer-implemented system, comprising one or more processors, and one or more non-transitory computer-readable media storing instructions that, when executed by the one or more processors, cause the one or more processors to perform a method according to any one of claims 29-42.

Example A provides block QP derivation 290 as described and illustrated herein.

Example B provides encoder 102 as described and illustrated herein.

Example C provides an encoding system having an encoder and block QP derivation 290 as described and illustrated herein.

### Variations and Remarks

One or more functionalities of block QP derivation 290 of FIGS. 2 and 4, block QP refinement 298 of FIGS. 2 and 8, and encoder 102 can be implemented as software instructions encoded in non-transitory computer-readable media, hardware logic or circuits, or both.

In some examples, block QP derivation 290 can be applied for intra-frames only. In some examples, block QP refinement 298 can be applied to intra- and/or inter-frames. The block QP derivation 290 and block QP refinement 298 can be independently deployable. Block QP derivation 290 can be used without block QP refinement 298, and vice versa. When used together, block QP derivation 290 provides a spatially-informed initial delta QP for intra-frames before encoding begins, and block QP refinement 298 subsequently refines the QP for any block (e.g., intra- or inter-coded blocks) where R-D theory is found to be unreliable.

Because block QP derivation 290 operates as a pre-processing stage outside the encoder 102, and block QP refinement 298 plugs into a well-defined point in the standard encode pipeline of encoder 102, neither requires changes to the codec's core syntax or bitstream format. The scheme is therefore codec-agnostic and applicable to AVC, HEVC, AV1, VP9, VVC, and future standards, in both software and hardware encoder implementations.

Block QP derivation 290 and block QP refinement 298 are complementary and independently deployable approaches that together close gaps left by other block-level QP adaptation solutions. Block QP derivation 290 fills the void in all-intra-encoding scenarios by introducing a spatial correlation metric that identifies which blocks are likely to serve as intra-prediction references and adjusts their QP accordingly. Block QP refinement 298 addresses a theoretically known but previously unhandled anomaly in R-D theory at the block-level, using a lightweight coefficient-counting heuristic to identify affected blocks and an adaptive search to correct their QP. Together, block QP derivation 290 and block QP refinement 298 expand the envelope of encoding efficiency across a broader range of content types, codec configurations, and deployment scenarios than any existing single solution.

The following example illustrates the combined operation of block QP derivation 290 and block QP refinement 298 of FIG. 2 on a single coding block. Consider an 8×8 block located in the interior of an intra-coded frame, having a frame QP of 32 and containing a repeated texture pattern, e.g., a section of a brick wall, that is highly similar to spatially neighboring blocks in encoding order. Block QP derivation 290 first computes the spatial correlation metric for this block using equation (1). The minimum SSD between the current block and its candidate neighbor blocks within the search region is small, producing a low corre_metric value of, for example, 18. This value falls in the range [0, 25] of the lookup table, yielding a per-block delta QP of −2. After aggregation across the enclosing 32×32 dQP block, the final delta QP for the dQP block is determined to be −1, reflecting that the majority of constituent 8×8 blocks are moderately well-correlated with their neighbors. The initial QP for this block is therefore set to 32+(−1)=31, and this value is passed to the transform and quantization stages of encoder 102. Following the transform stage (e.g., transform 214 of FIG. 2), block QP refinement 298 receives the transform coefficients for this block and derives the quantization step size QS corresponding to QP 31. Block QP refinement 298 then counts the number of transform coefficients whose magnitude exceeds QS. Suppose this count is 4, which exceeds the qualification threshold TQ of 3, classifying the block as a qualified block. Adaptive QP search 806 evaluates candidate QPs from QP 28 to QP 34 (e.g., a range of +3 around the initial QP of 31) by computing the rate-distortion cost for each candidate using the Lagrangian formulation. Suppose the RD-cost is minimized at QP 33, meaning that a slightly higher quantization step size reduces both distortion and bit rate for this block due to the discrete clustering of transform coefficients near integer multiples of the quantization step. Block QP refinement 298 selects QP 33 as the final QP for this block, and the quantization stage (e.g., quantization 215) quantizes the transform coefficients at QP 33. The result is a block that benefits from a spatially-informed initial delta QP derived by block QP derivation 290 and a further transform-domain refinement by block QP refinement 298, together achieving a lower rate-distortion cost than either solution would produce independently.

Although the operations of the example method shown in and described with reference to FIGS. 6-7, and 9-11 are illustrated as occurring once each and in a particular order, it will be recognized that some operations may be performed in any suitable order and repeated as desired. Additionally, one or more operations may be performed in parallel. Furthermore, the operations illustrated in FIGS. 6-7, and 9-11 may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. One or more non-transitory computer-readable media storing instructions that, when executed by one or more processors, cause the one or more processors to perform operations including:
determining, for a block of a video frame, a spatial correlation metric based on the block and one or more spatially neighboring blocks of the video frame;
determining a delta quantization parameter, from a lookup table, based on the spatial correlation metric;
determining a quantization parameter using the delta quantization parameter; and
encoding the block using the quantization parameter.

2. The one or more non-transitory computer-readable media of claim 1, wherein determining the spatial correlation metric comprises:
determining a minimum difference of one or more differences between the block and the one or more spatially neighboring blocks.

3. The one or more non-transitory computer-readable media of claim 2, wherein a difference between the block and a spatially neighboring block comprises a sum-square difference.

4. The one or more non-transitory computer-readable media of claim 2, wherein a difference between the block and a spatially neighboring block is normalized by a variance of luma pixels of the block.

5. The one or more non-transitory computer-readable media of claim 2, wherein a difference between the block and a spatially neighboring block is scaled by a calibration factor.

6. The one or more non-transitory computer-readable media of claim 1, wherein the one or more spatially neighboring blocks of the video frame includes one or more superblocks following the block in encoding order.

7. The one or more non-transitory computer-readable media of claim 1, wherein the lookup table is selected from a plurality of lookup tables based on a frame quantization parameter associated with the video frame.

8. The one or more non-transitory computer-readable media of claim 1, wherein determining the quantization parameter comprises:
determining the quantization parameter using the delta quantization parameter and one or more further delta quantization parameters determined for one or more further blocks of the video frame.

9. The one or more non-transitory computer-readable media of claim 1, wherein determining the quantization parameter comprises:
averaging the delta quantization parameter and one or more further delta quantization parameters determined for one or more further blocks of the video frame.

10. The one or more non-transitory computer-readable media of claim 1, wherein determining the quantization parameter comprises:
assigning a smallest delta quantization parameter based on classifying the block and one or more further blocks of the video frame as having screen content.

11. The one or more non-transitory computer-readable media of claim 1, wherein determining the quantization parameter comprises:
assigning a predefined nonnegative delta quantization parameter based on determining that the block is on a boundary of the video frame.

12. The one or more non-transitory computer-readable media of claim 1, wherein the operations further include:
based on the delta quantization parameter being equal to a further delta quantization parameter determined based on temporal correlation, assigning the delta quantization parameter or the further delta quantization parameter as the delta quantization parameter;
based on a product of the delta quantization parameter and the further delta quantization parameter being greater than or equal to zero, assigning a minimum of the delta quantization parameter and the further delta quantization parameter as the delta quantization parameter; and
based on the product of the delta quantization parameter and the further delta quantization parameter being less than zero, assigning a sum of the delta quantization parameter and the further delta quantization parameter as the delta quantization parameter.

13. The one or more non-transitory computer-readable media of claim 1, wherein the operations further include:
determining one or more transform coefficients for the block of the video frame; and
adjusting the quantization parameter based on the one or more transform coefficients and a quantization step corresponding to the quantization parameter.

14. The one or more non-transitory computer-readable media of claim 13, wherein adjusting the quantization parameter comprises:
based on the one or more transform coefficients and the quantization step meeting a refinement condition, evaluating one or more rate-distortion costs using one or more candidate quantization parameters, determining a selected quantization parameter based on the one or more rate-distortion costs; and setting the selected quantization parameter as the quantization parameter.

15. An apparatus, comprising:
one or more processors; and
one or more non-transitory computer-readable media storing instructions that, when executed by the one or more processors, cause the one or more processors to perform operations comprising:
determining, for a block of a video frame, a spatial correlation metric based on the block and one or more spatially neighboring blocks of the video frame;
determining a delta quantization parameter, from a lookup table, based on the spatial correlation metric;
determining a quantization parameter using the delta quantization parameter; and
encoding the block using the quantization parameter.

16. The apparatus of claim 15, wherein determining the spatial correlation metric comprises:
determining a minimum difference of one or more differences between the block and the one or more spatially neighboring blocks.

17. The apparatus of claim 16, wherein a difference between the block and a spatially neighboring block comprises a sum-square difference.

18. The apparatus of claim 16, wherein a difference between the block and a spatially neighboring block is normalized by a variance of luma pixels of the block.

19. A computer-implemented method, comprising:
determining, for a block of a video frame, a spatial correlation metric based on the block and one or more spatially neighboring blocks of the video frame;
determining a delta quantization parameter, from a lookup table, based on the spatial correlation metric;
determining a quantization parameter using the delta quantization parameter; and
encoding the block using the quantization parameter.

20. The computer-implemented method of claim 19, wherein determining the quantization parameter comprises:
averaging the delta quantization parameter and one or more further delta quantization parameters determined for one or more further blocks of the video frame.
